(19) United States
(12) Patent Application Publication
(10) Pub. No.: US 2024/0422795 A1
(43) Pub. Date: Dec. 19, 2024

(54) METHOD AND DEVICE IN NODES USED FOR WIRELESS COMMUNICATION

(71) Applicants: Lu WU, Shanghai (CN); Shulin SONG, Shanghai (CN); Xiaobo ZHANG, Shanghai (CN)

(72) Inventors: Lu WU, Shanghai (CN); Shulin SONG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/741,816

(22) Filed: Jun. 13, 2024

(30) Foreign Application Priority Data
Jun. 16, 2023 (CN) 202310721447.7

(51) Int. Cl. H04W 72/231; H04B 7/06; H04L 5/00; H04W 72/0457; H04W 76/20

(52) U.S. Cl. CPC H04W 72/231; H04B 7/06968; H04L 5/0051; H04W 72/0457; H04W 76/20

(57) ABSTRACT

A first node receives a reference information block; wherein the reference information block is used to configure a first CORESET pool on a first BWP, and the first CORESET pool comprises at least one CORESET; a first RS resource set is used for radio link quality assessment of the first BWP, the first RS resource set depends on a first TCI state set, the first TCI state set comprises at least one TCI state of at least one CORESET in the first CORESET pool; a target CORESET is a CORESET including two TCI states in the first CORESET pool; the two TCI states of the target CORESET respectively indicate QCL information of a DMRS antenna port for a PDCCH reception in the target CORESET in different PDCCH monitoring occasions. The above method flexibly adjusts a radio link quality assessment by determining appropriate RS resources.

### CROSS REFERENCE TO RELATED APPLICATIONS

This application claims the priority benefit of Chinese Patent Application No. 202310721447.7, filed on Jun. 8, 2023, the full disclosure of which is incorporated herein by reference.

### BACKGROUND

### Technical Field

The present application relates to transmission methods and devices in wireless communication systems, and in particular to a transmission scheme and device in a wireless communication system.

### Related Art

In existing NR (New Radio) systems, spectrum resources are statically divided into FDD (Frequency Division Duplexing) spectrum and TDD (Time Division Duplexing) spectrum. For the TDD spectrum, both the base station and User Equipment (UE) operate in half-duplex mode. This half-duplex mode avoids self-interference and can mitigate the impact of Cross Link interference, but also brings about a decrease in resource utilization rate and an increase in time delay. For these problems, supporting flexible duplex mode on the TDD spectrum or FDD spectrum becomes a possible solution. 3GPP RAN (Radio Access Network) 1 #103e meeting agreed on a research work for duplex technology, in which SubBand non-overlapping Full Duplex (SBFD) was proposed, i.e., the base station is supported to transmit and receive on two subbands at the same time. Communications in this mode is subject to severe interference, comprising both self-interference and cross-link interference.

### SUMMARY

Inventors have found through researches that it is a key issue to determine RS (Reference Signal) resources used for radio link quality assessment.

To address the above problem, the present application provides a solution. It should be noted that in the description of the application, flexible duplex mode is only used as a typical application scenario or example: the present application can also be applied to other scenarios facing similar problems (including but not limited to SBFD, other flexible duplex or full duplex modes, variable link direction modes, traditional duplex modes, half duplex modes, energy-saving scenarios, non energy-saving scenarios, capacity enhancement systems, close range communication systems, unlicensed frequency-domain communications, IoT (Internet of Things), URLLC (Ultra Reliable Low Latency Communication) networks, Internet of Vehicles (IoV), etc.), where similar technical effects can be achieved. Additionally, adopting a unified design approach for different scenarios can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a reference information block;
herein, the reference information block is used to configure a first CORESET (Control Resource Set) pool on a first BWP (BandWidth Part), and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, a problem to be solved in the present application comprises: how to determine RS resources used for radio link quality assessment.

In one embodiment, the benefit of using the above method is that radio link quality assessment is flexibly adjusted by identifying suitable RS resources.

In one embodiment, the advantage of using the above method is that it improves the accuracy of radio link quality assessment and improves the system performance by determining suitable RS resources.

In one embodiment, advantages of the above method comprise: performing beam failure monitoring based on radio link quality assessment, so as to restore link quality and ensure system stability.

In one embodiment, benefits of the present application include: improving transmission reliability.

In one embodiment, benefits of the present application include: increasing system flexibility.

According to one aspect of the present application, comprising:

receiving a first information block:
herein, the first information block is used to determine a reference time-domain resource set: the two TCI states of the target CORESET respectively indicate QCL information of a DMRS antenna port for a PDCCH reception in the target CORESET in a PDCCH monitoring occasion in the reference time-domain resource set, and QCL information of a DMRS antenna port for a PDCCH reception in the target CORESET in a PDCCH monitoring occasion outside the reference time-domain resource set.

In one embodiment, advantages of adopting the above method comprise: being suitable for different application scenarios/environment/modes, improving the flexibility of the system.

In one embodiment, the above method supports flexible duplex mode, improves uplink coverage, and increases uplink transmission capacity.

In one embodiment, the above method supports SBFD technology, improves uplink coverage, and increases uplink transmission capacity.

According to one aspect of the present application, it is characterized in that the first TCI state set comprises a TCI state indicating QCL information of a DMRS antenna port for a PDCCH reception in the target CORESET in a PDCCH monitoring occasion outside the reference time-domain resource set in the two TCI states of the target CORESET.

In one embodiment, advantages of adopting the above method comprise: having good backward compatibility and simplifying the design of radio link quality assessment.

According to one aspect of the present application, it is characterized in that configuration information of the first serving cell does not comprise a higher-layer parameter configuring SFN (Single Frequency Network) scheme for PDCCH: or, configuration information of the target CORESET does not comprise a higher-layer parameter for configuring a PDCCH to use SFN scheme.

In one embodiment, the above method supports determining two TCI states based on a target CORESET in non-SFN schemes, improving the flexibility of radio link quality assessment.

According to one aspect of the present application, it is characterized in that a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

In one embodiment, advantages of the above method comprise: flexibly selecting RS resources used for beam failure recovery of a first BWP based on two TCI states of a reference CORESET.

According to one aspect of the present application, it is characterized in that when a value of a target counter is equal to or greater than a target threshold, a beam failure recovery for a first serving cell is triggered; herein, the first BWP is a BWP of the first serving cell: when the radio link quality assessed according to the first RS resource set is worse than a reference threshold, physical layer of the first node transmits a beam failure instance indication for the first serving cell to its higher layer: the target counter is used for counting the beam failure instance indication for the first serving cell.

In one embodiment, advantages of the above method comprise: radio link quality assessment based on a first RS resource set is used to determine whether a beam failure recovery of a first serving cell is triggered, thus ensuring the stability of the system.

According to one aspect of the present application, it is characterized in that the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool: when the radio link quality assessed according to the first RS resource set is worse than a reference threshold, physical layer of the first node transmits a beam failure instance indication for the first RS resource set to its higher layer: when the radio link quality assessed according to the second RS resource set is worse than the reference threshold, physical layer of the first node transmits a beam failure instance indication for the second RS resource set to its higher layer.

In one embodiment, the above method can be applied to M-TRP (Multi-Transmitter Receiver Point) scenario, where radio link quality assessment is performed separately for each TRP, thus improving transmission reliability and system flexibility:

The present application provides a method in a second node for wireless communications, comprising:
transmitting a reference information block;
herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

According to one aspect of the present application, comprising:
transmitting a first information block;
herein, the first information block is used to determine a reference time-domain resource set: the two TCI states of the target CORESET respectively indicate QCL information of a DMRS antenna port for a PDCCH reception in the target CORESET in a PDCCH monitoring occasion in the reference time-domain resource set, and QCL information of a DMRS antenna port for a PDCCH reception in the target CORESET in a PDCCH monitoring occasion outside the reference time-domain resource set.

According to one aspect of the present application, it is characterized in that the first TCI state set comprises a TCI state indicating QCL information of a DMRS antenna port for a PDCCH reception in the target CORESET in a PDCCH monitoring occasion outside the reference time-domain resource set in the two TCI states of the target CORESET.

According to one aspect of the present application, it is characterized in that configuration information of the first serving cell does not comprise a higher-layer parameter configuring SFN (Single Frequency Network) scheme for PDCCH: or, configuration information of the target CORESET does not comprise a higher-layer parameter for configuring a PDCCH to use SFN scheme.

According to one aspect of the present application, it is characterized in that a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

According to one aspect of the present application, it is characterized in that when a value of a target counter is equal to or greater than a target threshold, a beam failure recovery for a first serving cell is triggered; herein, the first BWP is a BWP of the first serving cell: when the radio link quality assessed according to the first RS resource set is worse than a reference threshold, physical layer of a receiver of the reference information block transmits a beam failure instance indication for the first serving cell to its higher layer: the target counter is used for counting the beam failure instance indication for the first serving cell.

According to one aspect of the present application, it is characterized in that the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool: when the radio link quality assessed according to the first RS resource set is worse than a reference threshold, physical layer of a receiver of the reference information block transmits a beam failure instance indication for the first RS resource set to its higher layer: when the radio link quality assessed according to the second RS resource set is worse than the reference threshold, physical layer of the receiver of the reference information block transmits a beam failure instance indication for the second RS resource set to its higher layer.

The present application provides a first node for wireless communications, comprising:
a first receiver, receiving a reference information block;
herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

The present application provides a second node for wireless communications, comprising:
a second transmitter, transmitting a reference information block;
herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool; a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions; the first TCI state set comprises only one of the two TCI states of the target CORESET.

In one embodiment, the present application has the following advantages over conventional schemes:
by identifying suitable RS resources, flexibly adjusting radio link quality assessment;
being suitable for different application scenarios/environment/modes, improving the flexibility of the system;
improving the system reliability;
increasing the transmission capacity;
improving the system performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a reference information block according to one embodiment of the present application;

FIG. 2 illustrates a schematic diagram of a network architecture according to one embodiment of the present application:

FIG. 3 illustrates a schematic diagram of a radio protocol architecture of a user plane and a control plane according to one embodiment of the present application:

FIG. 4 illustrates a schematic diagram of a first communication device and a second communication device according to one embodiment of the present application:

FIG. 5 illustrates a flowchart of wireless transmission according to one embodiment of the present application:

FIG. 6 illustrates a schematic diagram of a first information block according to one embodiment of the present application:

FIG. 7 illustrates a schematic diagram of a first TCI state set according to one embodiment of the present application:

FIGS. 8A-8B illustrate a schematic diagram of configuration information of a first serving cell and a target CORESET according to one embodiment of the present application:

FIG. 9 illustrates a schematic diagram of a relation between a first TCI state and two TCI states of a reference CORESET according to one embodiment of the present application:

FIG. 10 illustrates a schematic diagram of triggering a beam failure recovery for a first serving cell according to one embodiment of the present application:

FIG. 11 illustrates a schematic diagram of a radio link quality assessment of a first BWP according to one embodiment of the present application:

FIG. 12 illustrates a structure block diagram of a processor in a first node according to one embodiment of the present application:

FIG. 13 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

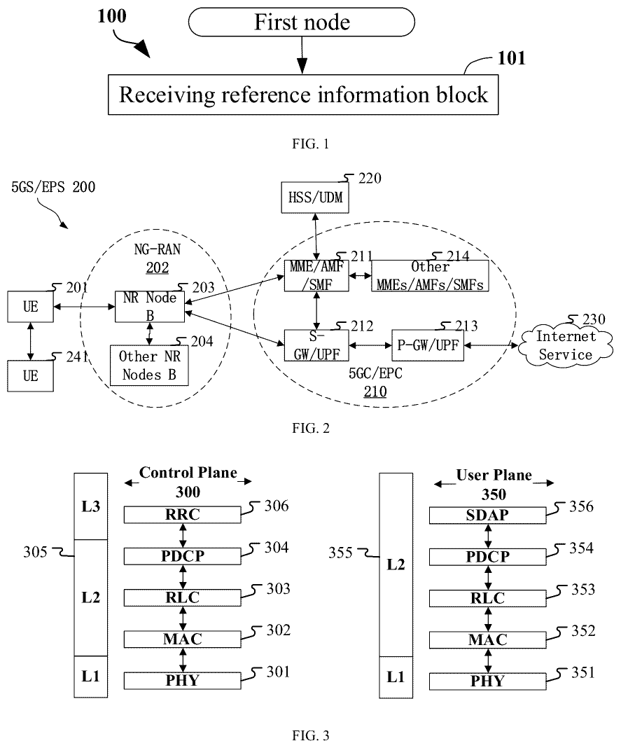

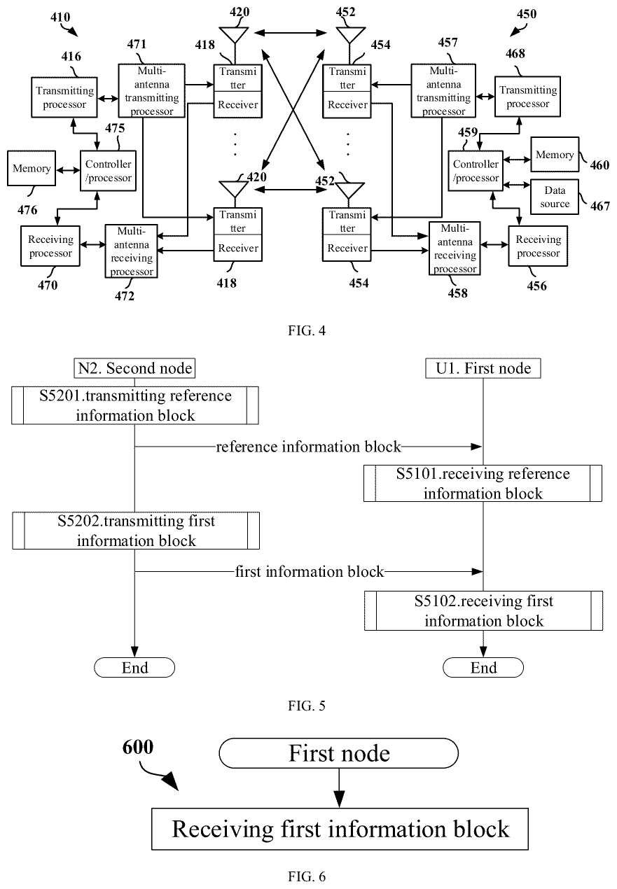

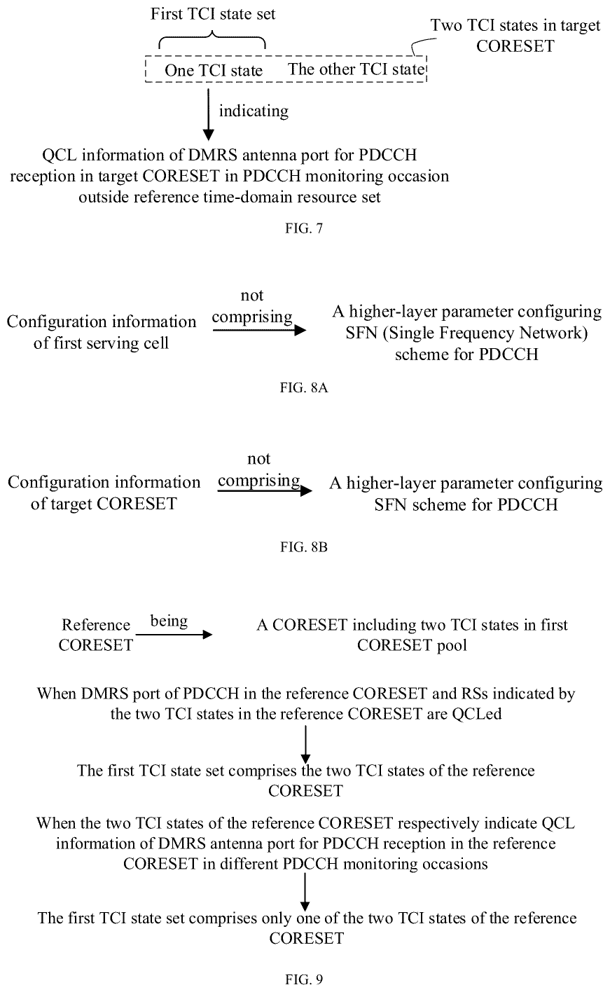

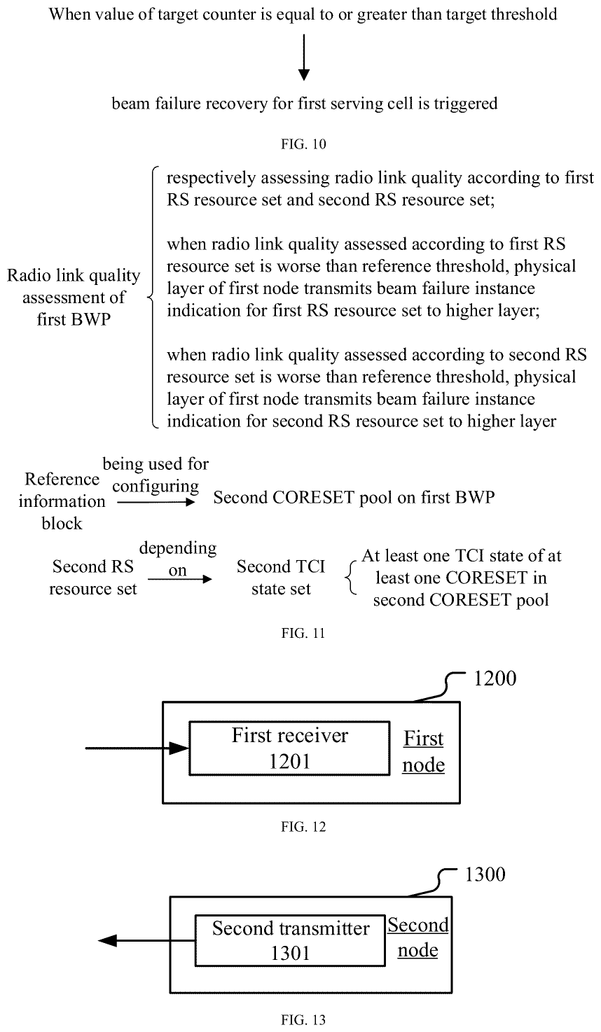

Embodiment 1 illustrates a flowchart of a reference information block according to one embodiment of the present application, as shown in FIG. 1. In step 100 illustrated by FIG. 1, each box represents a step.

In Embodiment 1, the first node in the present application receives a reference information block in step 101: herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool; a target CORESET is a CORESET including two TCI states in the first CORESET pool; the two TCI states of the target CORESET respectively indicate QCL (quasi co-location) information of a DMRS antenna port for a PDCCH reception in the target CORESET in different PDCCH monitoring occasions; the first TCI state set comprises only one of the two TCI states of the target CORESET.

In one embodiment, the reference information block comprises an RRC message.

In one embodiment, the reference information block comprises at least an RRC message in an RRC message or a MAC CE message.

In one embodiment, the reference information block comprises an RRC message and a MAC CE message.

In one embodiment, the reference information block comprises partial or all fields in one or multiple RRC IEs (Information Elements).

In one embodiment, the reference information block comprises partial or all fields in an RRC IE.

In one embodiment, the reference information block comprises partial or all fields in at least one RRC IE.

In one embodiment, the reference information block comprises a controllResourceSetToAddModList field in an RRC IE.

In one embodiment, the reference information block comprises a field whose name comprises controlResourceSetToAddModList in an RRC IE.

In one embodiment, the reference information block comprises a field whose name comprises controlResourceSet in an RRC IE.

In one embodiment, the reference information block indicates an index of a CORESET in a first CORESET (control resource set) pool on a first BWP.

In one embodiment, the reference information block indicates configuration information of a CORESET in a first CORESET pool on a first BWP.

In one embodiment, “a CORESET in a first CORESET pool” refers to: any CORESET in a first CORESET pool.

In one embodiment, “a CORESET in a first CORESET pool” refers to: each CORESET in a first CORESET pool.

In one embodiment, “a CORESET in a first CORESET pool” refers to: at least one CORESET in a first CORESET pool.

In one embodiment, “a CORESET in a first CORESET pool” refers to: partial CORESETs in a first CORESET pool.

In one embodiment, “a CORESET in a first CORESET pool” refers to: all CORESETs in a first CORESET pool.

In one embodiment, configuration information of a CORESET comprises a corresponding index, an occupied RB (Resource Block), occupied consecutive symbols, a TCI (Transmission Configuration Indication) state, CCE (Control channel element) to REG (Resource Element Group) mapping parameters, precoding granularity and a DM-RS scrambling sequence initialization value.

In one embodiment, configuration information of a CORESET comprises a corresponding index, an occupied RB, occupied consecutive symbols, and a TCI state.

Typically, a TCI state in configuration information of a CORESET indicates that antenna ports of the CORESET are QCLed.

In one embodiment, the first CORESET pool comprises one or multiple CORESETs.

In one embodiment, the first CORESET pool comprises multiple CORESETs.

In one embodiment, the first CORESET pool comprises at most 3 CORESETs.

In one embodiment, the first CORESET pool comprises at most 5 CORESETs.

Typically, the first RS resource set is a beam failure detection RS set.

In one embodiment, the first RS resource set comprises at one RS resource.

In one embodiment, the RS resources are either SS/PBCH (Synchronization Signal/Physical Broadcast Channel) block resources or CSI-RS (Channel State Information Reference Signal) resources.

In one embodiment, the RS resources are SSB (Synchronization Signal Block) resources or CSI-RS resources.

In one embodiment, the RS resources are CSI-RS resources.

In one embodiment, the RS resources are periodic CSI-RS resources.

In one embodiment, the RS resources are NZP (Non-Zero Power) CSI-RS resources.

In one embodiment, the RS resources are periodic NZP (Non-Zero Power) CSI-RS resources.

In one embodiment, the RS resources are SS/PBCH block resources.

In one embodiment, the RS resources are SSB resources.

In one embodiment, the first RS resource set comprises at one periodic CSI-RS resource.

In one embodiment, the first RS resource set comprises at least one SS/PBCH block resource.

In one embodiment, the first RS resource set comprises at one periodic CSI-RS resource or at least one SS/PBCH block resource.

In one embodiment, the first RS resource set comprises at one periodic CSI-RS resource and at least one SS/PBCH block resource.

In one embodiment, the first node is not configured with the first RS resource set by higher-layer parameters.

In one subembodiment of the above embodiment, the higher-layer parameters comprise at least one of failureDetection Resources ToAddModList, failureDetectionSet1 or failureDetectionSet2.

In one embodiment, for specific meanings of failureDetectionResourcesToAddModList, failureDetectionSet1 and failureDetectionSet2, refer to chapter 6 in 3GPP TS38.213.

In one embodiment, the first RS resource set is set q̅₀.

In one embodiment, the first RS resource set is set q̅_{0,0}.

In one embodiment, the first RS resource set is set q̅₀ or set q̅_{0,0}.

In one embodiment, radio link quality assessment is used for beam failure monitoring.

In one embodiment, radio link quality assessment comprises a determination of whether radio link quality is worse than a reference threshold.

In one embodiment, the radio link quality is RSRP.

In one embodiment, the radio link quality is L1-RSRP.

In one embodiment, the radio link quality is SINR.

In one embodiment, the radio link quality is L1-SINR.

In one embodiment, the radio link quality is BLER.

In one embodiment, the radio link quality is hypothetical BLER.

In one embodiment, only a first RS resource set is used for radio link quality assessment of the first BWP.

In one embodiment, a first RS resource set and RS resources outside the first RS resource set are used for radio link quality assessment of the first BWP.

In one embodiment, a first RS resource set and a second RS resource set are used for a radio link quality assessment of the first BWP.

In one embodiment, radio link quality assessment of the first BWP comprises: assessing radio link quality based on a first RS resource set.

In one embodiment, the radio link quality assessment of the first BWP comprises: respectively assessing radio link quality according to the first RS resource set and a second RS resource set.

In one embodiment, radio link quality assessment of the first BWP refers to: assessing radio link quality based on a first RS resource set.

In one embodiment, radio link quality assessment of the first BWP refers to: respectively assessing radio link quality based on the first RS resource set and a second RS resource set.

In one embodiment, the meaning of “assessing radio link quality based on a given RS resource set” comprises: assessing radio link quality based on all RS resources in a given RS resource set.

In one embodiment, the radio link quality is one of RSRP (Reference Signal Received Power), L1-RSRP (Layer1-RSRP), SINR (Signal to Interference plus Noise Ratio), or L1-SINR (Layer1-SINR), and the meaning of “assessing radio link quality according to a given RS resource set” comprises: the radio link quality is a maximum value in RSRP, L1-RSRP, SINR, or L1-SINR measured based on all RS resources in the given RS resource set.

In one embodiment, the radio link quality is a BLER (Block Error Rate), and the meaning of “assessing radio link quality based on a given RS resource set” comprises: the radio link quality is a minimum value of BLER measured based on all RS resources in the given RS resource set.

In one embodiment, the radio link quality is a hypothetical BLER (Block Error Rate), and the meaning of “assessing radio link quality based on a given RS resource set” comprises: the radio link quality is a minimum value of a hypothetical BLER measured based on all RS resources in the given RS resource set.

In one embodiment, the radio link quality is one of RSRP, L1-RSRP, SINR, or L1-SINR, and the meaning of “assessing radio link quality based on a given RS resource set” comprises: the radio link quality is an average value of RSRP, L1-RSRP, SINR, or L1-SINR measured based on all RS resources in the given RS resource set.

In one embodiment, the radio link quality is a BLER (Block Error Rate), and the meaning of “assessing radio link quality based on a given RS resource set” comprises: the radio link quality is an average value of a BLER measured based on all RS resources in the given RS resource set.

In one embodiment, the radio link quality is a hypothetical BLER (Block Error Rate), and the meaning of “assessing radio link quality based on a given RS resource set” comprises: the radio link quality is an average value of a hypothetical BLER measured based on all RS resources in the given RS resource set.

In one embodiment, the given RS resource set is the second RS resource set.

In one embodiment, the given RS resource set is the first RS resource set.

In one embodiment, the two TCI states of the target CORESET comprise a first TCI state and a second TCI state; the first TCI state indicates QCL information of a DMRS antenna port for a PDCCH reception in the target CORESET in a PDCCH monitoring occasion outside the reference time-domain resource set; the second TCI state indicates QCL information of a DMRS antenna port for a PDCCH reception in the target CORESET in a PDCCH monitoring occasion in the reference time-domain resource set.

In one embodiment, the first TCI state is a first one of TCI states in the two TCI states of the target CORESET.

In one embodiment, a position of the first TCI state in the two TCI states of the target CORESET is configurable.

In one embodiment, the first TCI state is a second one of TCI states in the two TCI states of the target CORESET.

In one embodiment, the two TCI states of the target CORESET are both active.

In one embodiment, the two TCI states of the target CORESET are configured or activated by a same signaling.

In one embodiment, the two TCI states of the target CORESET belong to configuration information of the target CORESET.

In one embodiment, the two TCI states of the target CORESET correspond to two types of symbols.

In one embodiment, only one of the two types of symbols is used for DL (DownLink) transmission.

In one embodiment, only one of the two types of symbols supports UL (UpLink) transmission.

In one embodiment, only one of the two types of symbols supports DL transmission and UL (UpLink) transmission.

In one embodiment, one of the two types of symbols only supports DL (DownLink) transmission, and the other one of the two types of symbols supports DL (DownLink) transmission and UL transmission.

In one embodiment, the two types of symbols are configured by higher-layer parameters as DL; one of the two types of symbols only supports DL (DownLink) transmission, and the other one of the two types of symbols supports DL (DownLink) transmission and UL transmission.

In one embodiment, any of the two types of symbols is configured as DL or Flexible by higher-layer parameters.

In one embodiment, the two types of symbols are configured by higher-layer parameters as DL.

In one embodiment, any of the two types of symbols is configured as DL or Flexible by higher-layer parameters: the two types of symbols are SBFD symbols and non-SBFD symbols.

In one embodiment, the two types of symbols are SBFD symbols and non-SBFD symbols.

In one embodiment, the two types of symbols support SBFD and non-SBFD respectively.

In one embodiment, the non-SBFD symbol is a DL symbol.

In one embodiment, the non-SBFD symbol is a DL symbol or a Flexible symbol.

In one embodiment, types of the two types of symbols are respectively a first type and a type other than the first type.

In one embodiment, types of the two types of symbols are different, and types of the two types of symbols are a first type and DL, respectively.

In one embodiment, types of the two types of symbols are different.

In one embodiment, a type of one of the two types of symbols is a first type, and a type of the other one of the two types of symbol is DL.

In one embodiment, a type of one of the two types of symbols is a first type, and a type of the other one of the two types of symbol is DL or Flexible.

In one embodiment, a symbol of the first type is an SBFD symbol.

In one embodiment, the two types of symbols are configured as DL by higher-layer parameters, with one type of the two types of symbols being a first type and the other one of the two types of symbols being DL.

In one embodiment, the two types of symbols are configured as DL or Flexible by higher-layer parameters, with one type of the two types of symbols being a first type and the other one of the two types of symbols being DL or Flexible.

In one embodiment, a symbol of a first type is configured as DL by higher-layer parameters, and one or multiple subcarriers in the symbol of the first type are used for UL transmission.

In one embodiment, a symbol of a first type is configured as DL by higher-layer parameters, and one or multiple RBs in the symbol of the first type are used for UL transmission.

In one embodiment, a symbol of a first type is configured as DL by higher-layer parameters, and the symbol of the first type supports UL transmission.

In one embodiment, the higher-layer parameters are an RRC parameter.

In one embodiment, the higher-layer parameters comprise tdd-UL-DL-ConfigurationDedicated.

In one embodiment, the higher-layer parameters comprise tdd-UL-DL-ConfigurationCommon and tdd-UL-DL-ConfigurationDedicated.

In one embodiment, the higher-layer parameters comprise at least one of tdd-UL-DL-ConfigurationCommon or tdd-UL-DL-ConfigurationDedicated.

In one embodiment, for specific meaning of the tdd-UL-DL-ConfigurationCommon and tdd-UL-DL-ConfigurationDedicated, refer to chapter 11 in 3GPP TS38.213.

In one embodiment, the two TCI states of the target CORESET respectively indicate QCL information of a DMRS antenna port for a PDCCH reception in the target CORESET on two types of symbols.

In one embodiment, the two TCI states of the target CORESET respectively correspond to orthogonal time-domain resources.

In one embodiment, the two TCI states of the target CORESET respectively indicate QCL information of a DMRS antenna port for a PDCCH reception in the target CORESET in two orthogonal time-domain resource sets.

In one embodiment, the two TCI states of the target CORESET respectively indicate QCL information of a DMRS antenna port for a PDCCH reception in the target CORESET in two orthogonal PDCCH monitoring occasions.

In one embodiment, the two TCI states of the target CORESET respectively indicate QCL information of a DMRS antenna port for a PDCCH reception in the target CORESET in two groups of orthogonal PDCCH monitoring occasions.

In one embodiment, in a PDCCH monitoring occasion, QCL information of a DMRS antenna port for a PDCCH reception in the target CORESET is indicated by only one of the two TCI states in the target CORESET.

In one embodiment, any TCI state in the first TCI state set indicates an RS resource configured with QCL type ‘typeD’.

In one embodiment, the first TCI state set comprises at least one TCI state of at least one CORESET used for monitoring a PDCCH in the first CORESET pool.

In one embodiment, the first TCI state set comprises at least one TCI state of each CORESET in a first CORESET group: CORESETs used for monitoring a PDCCH in the first CORESET pool are sorted according to a first rule, and the first CORESET group comprises a first positive integer number of CORESET(s) used for monitoring a PDCCH in the first CORESET pool: the first rule comprises sorting in an ascending order according to PDCCH monitoring cycle, and sorting a descending order according to CORESET index under a same PDCCH monitoring cycle.

In one embodiment, a maximum number of TCI states comprised in any CORESET in the first CORESET pool is 2.

In one embodiment, a maximum number of TCI states comprised in any CORESET in the first CORESET pool is NBFD.

In one embodiment, a maximum number of TCI states comprised in any CORESET in the first CORESET pool is configured by parameter maxBFD-RS resourcesPerSetPerBWP.

In one embodiment, the first TCI state set comprises only a first one of TCI state in the two TCI states of the target CORESET.

In one embodiment, the first TCI state set comprises which of the two TCI states of the target CORESET is configurable.

In one embodiment, the first TCI state set comprises which of the two TCI states of the target CORESET is pre-defined.

In one embodiment, the first TCI state set comprises which of the two TCI states of the target CORESET depends on a corresponding PDCCH monitoring occasion.

In one embodiment, the two TCI states of the target CORESET correspond to two types of symbols; which of the two TCI states of the target CORESET is comprised in the first TCI state set depends on whether a corresponding symbol type is a first type.

In one embodiment, the two TCI states of the target CORESET correspond to two types of symbols; the first TCI state set comprises a TCI state corresponding to a first type in the two TCI states of the target CORESET.

In one embodiment, the two TCI states of the target CORESET respectively correspond to orthogonal time-domain resources.

In one embodiment, the first TCI state set comprises which of the two TCI states of the target CORESET depends on a relation between a corresponding PDCCH monitoring occasion and a reference time-domain resource set.

In one embodiment, the first TCI state set comprises which of the two TCI states of the target CORESET depends on whether a corresponding PDCCH monitoring occasion is orthogonal to a reference time-domain resource set.

In one embodiment, the meaning of the phrase that “the first RS resource set depends on a first TCI state set” comprises: the first RS resource set is determined based on an RS index in an RS set indicated by the first TCI state set.

In one embodiment, the meaning of the phrase that “the first RS resource set depends on a first TCI state set” comprises: the first RS resource set is determined based on an RS index configured with QCL type ‘typeD’ in an RS set indicated by the first TCI state set.

In one embodiment, the meaning of the phrase that “the first RS resource set depends on a first TCI state set” comprises: the first RS resource set comprises at least one RS resource in an RS set indicated by the first TCI state set.

In one embodiment, the meaning of the phrase that “the first RS resource set depends on a first TCI state set” comprises: the first RS resource set comprises RS resources configured with QCL type ‘typeD’ in an RS set indicated by the first TCI state set.

In one embodiment, the meaning of the phrase that “the first RS resource set depends on a first TCI state set” comprises: the first RS resource set is determined based on a periodic CSI-RS resource configuration index with a same value as an RS index in an RS set indicated by the first TCI state set.

In one embodiment, the meaning of the phrase that “the first RS resource set depends on a first TCI state set” comprises: the first RS resource set is determined based on a periodic CSI-RS resource configuration index with a same value as an RS index configured with QCL type ‘typeD’ in an RS set indicated by the first TCI state set.

In one embodiment, the meaning of the phrase that “the first RS resource set depends on a first TCI state set” comprises: the first RS resource set is determined based on a periodic CSI-RS resource configuration index with a same value as an RS index in an RS set indicated by the first TCI state set; for a TCI state indicating multiple RS resources in the first TCI state set, the first RS resource set only comprises RS resources configured with QCL type ‘typeD’.

In one embodiment, the meaning of the phrase that “the first RS resource set depends on a first TCI state set” comprises: the first RS resource set comprises at least one periodic CSI-RS resource, and an index of the at least one periodic CSI-RS resource is the same as an RS index in an RS set indicated by the first TCI state set.

In one embodiment, the meaning of the phrase that “the first RS resource set depends on a first TCI state set” comprises: the first RS resource set comprises at least one periodic CSI-RS resource, and an index of the at least one periodic CSI-RS resource is the same as an RS index configured with QCL type ‘typeD’ in an RS set indicated by the first TCI state set.

In one embodiment, the meaning of the phrase that “the first RS resource set depends on a first TCI state set” comprises: the first RS resource set comprises at least one periodic CSI-RS resource, and an index of the at least one periodic CSI-RS resource is the same as an RS index in an RS set indicated by the first TCI state set: for a TCI state indicating multiple RS resources in the first TCI state set, the first RS resource set only comprises RS resources configured with QCL type ‘typeD’.

In one embodiment, the meaning of the phrase that “the first RS resource set depends on a first TCI state set” comprises: the first RS resource set is determined based on an SS/PBCH block index with a same value as an RS index in an RS set indicated by the first TCI state set.

In one embodiment, the meaning of the phrase that “the first RS resource set depends on a first TCI state set” comprises: the first RS resource set is determined based on an SS/PBCH block index with a same value as an RS index configured with QCL type ‘typeD’ in an RS set indicated by the first TCI state set.

In one embodiment, the meaning of the phrase that “the first RS resource set depends on a first TCI state set” comprises: the first RS resource set is determined based on an SS/PBCH block index with a same value as an RS index in an RS set indicated by the first TCI state set: for a TCI state indicating multiple RS resources in the first TCI state set, the first RS resource set only comprises RS resources configured with QCL type ‘typeD’.

In one embodiment, the meaning of the phrase that “the first RS resource set depends on a first TCI state set” comprises: the first RS resource set comprises at least one SS/PBCH block, and an index of the at least one SS/PBCH block is the same as an RS index in an RS set indicated by the first TCI state set.

In one embodiment, the meaning of the phrase that “the first RS resource set depends on a first TCI state set” comprises: the first RS resource set comprises at least one SS/PBCH block, and an index of the at least one SS/PBCH block is the same as an RS index configured with QCL type ‘typeD’ in an RS set indicated by the first TCI state set.

In one embodiment, the meaning of the phrase that “the first RS resource set depends on a first TCI state set” comprises: the first RS resource set comprises at least one SS/PBCH block, and an index of the at least one SS/PBCH block is the same as an RS index in an RS set indicated by the first TCI state set: for a TCI state indicating multiple RS resources in the first TCI state set, the first RS resource set only comprises RS resources configured with QCL type ‘typeD’.

In one embodiment, the meaning of the phrase that “an index of the at least one periodic CSI-RS resource is the same as an RS index in an RS set indicated by the first TCI state set” comprises: an index of the at least one periodic CSI-RS resource comprises at least one RS index in an RS set indicated by the first TCI state set.

In one embodiment, the meaning of the phrase that “an index of the at least one periodic CSI-RS resource is the same as an RS index in an RS set indicated by the first TCI state set” comprises: an index of the at least one periodic CSI-RS resource comprises an RS index configured with QCL type ‘typeD’ in an RS set indicated by the first TCI state set.

In one embodiment, the meaning of the phrase that “an index of the at least one periodic CSI-RS resource is the same as an RS index in an RS set indicated by the first TCI state set” comprises: an index of the at least one periodic CSI-RS resource is the same as an RS index configured with QCL type ‘typeD’ in an RS set indicated by the first TCI state set.

In one embodiment, the meaning of the phrase that “an index of the at least one periodic CSI-RS resource is the same as an RS index in an RS set indicated by the first TCI state set” comprises: an index of any periodic CSI-RS resource in the at least one periodic CSI-RS resource is the same as an RS index indicated by a TCI state in the first TCI state set, and an RS index indicated by any TCI state in the first TCI state set is the same as an index of a periodic CSI-RS resource in the first RS resource set.

In one embodiment, an index of a CSI-RS resource is a CSI-RS resource configuration index.

In one embodiment, an index of a CSI-RS resource is used to identify the CSI-RS resource.

In one embodiment, an index of a CSI-RS resource is used to identify a configuration of the CSI-RS resource.

In one embodiment, the meaning of the phrase that “an index of the at least one SS/PBCH block is the same as an RS index in an RS set indicated by the first TCI state set” comprises: an index of the at least one SS/PBCH block comprises at least one RS index in an RS set indicated by the first TCI state set.

In one embodiment, the meaning of the phrase that “an index of the at least one SS/PBCH block is the same as an RS index in an RS set indicated by the first TCI state set” comprises: an index of the at least one SS/PBCH block comprises an RS index configured with QCL type ‘typeD’ in an RS set indicated by the first TCI state set.

In one embodiment, the meaning of the phrase that “an index of the at least one SS/PBCH block is the same as an RS index in an RS set indicated by the first TCI state set” comprises: an index of the at least one SS/PBCH block is the same as an RS index configured with QCL type ‘typeD’ in an RS set indicated by the first TCI state set.

In one embodiment, the meaning of the phrase that “an index of the at least one SS/PBCH block is the same as an RS index in an RS set indicated by the first TCI state set” comprises: an index of any SS/PBCH block in at least one SS/PBCH block is the same as an RS index indicated by a TCI state in the first TCI state set, and an RS index indicated by any TCI state in the first TCI state is the same as an index of an SS/PBCH block in the first RS resource set.

In one embodiment, an index of an SS/PBCH block is used to identify the SS/PBCH block.

In one embodiment, an index of an SS/PBCH block is used to identify a configuration of the SS/PBCH block.

In one embodiment, an index of a CSI-RS resource is an NZP-CSI-RS-ResourceId.

In one embodiment, an index of an SS/PBCH block is SSB-Index.

In one embodiment, the SS/PBCH block refers to an SSB (Synchronization Signal Block).

In one embodiment, any TCI state in the first TCI state set indicates QCL information of a DMRS antenna port for a PDCCH reception in a CORESET in a first CORESET pool.

In one embodiment, any TCI state in the first TCI state set indicates QCL information of a DMRS antenna port for a PDCCH reception in a CORESET in a first CORESET pool in at least one PDCCH monitoring occasion.

In one embodiment, any TCI state in the first TCI state set indicates all or partial QCL information of a DMRS antenna port for a PDCCH reception in a CORESET in a first CORESET pool in at least one PDCCH monitoring occasion.

In one embodiment, configuration information of a CORESET comprises one or two TCI states.

In one embodiment, a TCI state of a CORESET belongs to configuration information of the CORESET.

In one embodiment, a TCI state of a CORESET indicates QCL information of a DMRS antenna port for a PDCCH reception in the CORESET in a PDCCH monitoring occasion.

In one embodiment, a CORESET comprises only one TCI state, and the TCI state of the CORESET indicates QCL information of a DMRS antenna port for a PDCCH reception in the CORESET.

In one embodiment, a CORESET comprises two TCI states, and the two TCI states respectively indicate QCL information of a DMRS antenna port for a PDCCH reception in the CORESET at different PDCCH monitoring occasions.

In one embodiment, the two TCI states of the target CORESET indicate RS resources configured with QCL type ‘typeD’.

In one embodiment, only when the two TCI states of the target CORESET respectively indicate QCL information of a DMRS antenna port for a PDCCH reception at different PDCCH monitoring occasions, the first TCI state set comprises only one of the two TCI states of the target CORESET.

In one embodiment, in a PDCCH monitoring occasion, a DMRS port of a PDCCH in the target CORESET and only one TCI state in the two TCI states in the target CORESET are QCLed.

In one embodiment, the two TCI states in the target CORESET are not simultaneously used to receive a PDCCH in the target CORESET.

In one embodiment, the meaning of “a TCI state of a CORESET indicates QCL information of a DMRS antenna port for a PDCCH reception in the CORESET” comprises: QCL characteristics of RS resources indicated by a TCI state of a CORESET are the same as QCL characteristics of the CORESET.

In one embodiment, the meaning that “QCL characteristics of RS resources indicated by a TCI state of a CORESET are the same as QCL characteristics of the CORESET” comprises: the first node assumes that QCL characteristics of RS resources indicated by a TCI state of a CORESET are the same as QCL characteristics of the CORESET.

In one embodiment, the meaning of “a TCI state of a CORESET indicates QCL information of a DMRS antenna port for a PDCCH reception in the CORESET” comprises: QCL parameters of RS resources indicated by a TCI state of a CORESET are the same as QCL parameters of the CORESET.

In one embodiment, the meaning that “QCL characteristics of RS resources indicated by a TCI state of a CORESET are the same as QCL characteristics of the CORESET” comprises: the first node assumes that QCL parameters of RS resources indicated by a TCI state of a CORESET are the same as QCL parameters of the CORESET.

In one embodiment, the meaning of “a TCI state of a CORESET indicates QCL information of a DMRS antenna port for a PDCCH reception in the CORESET” comprises: a TCI state of a CORESET indicates a quasi co-location relationship between “at least one RS resource” and “a DMRS antenna port for a PDCCH reception in the CORESET.”.

In one embodiment, the meaning of “a TCI state of a CORESET indicates QCL information of a DMRS antenna port for a PDCCH reception in the CORESET” comprises: at least one reference signal resource indicated by a TCI state of a CORESET and a DMRS antenna port for a PDCCH reception in the CORESET are quasi co-located.

In one embodiment, the QCL information comprises QCL characteristics.

In one embodiment, the QCL information comprises QCL parameters.

In one embodiment, the QCL characteristics comprises QCL parameters.

In one embodiment, the QCL characteristics comprises QCL type ‘typeD’.

In one embodiment, the QCL characteristics comprises one of QCL types ‘typeA’, ‘typeB’, ‘typeC’, or ‘typeD’.

In one embodiment, a TCI state indicates at least one RS resource and a QCL type corresponding to each RS resource.

In one embodiment, RS resources indicated by a TCI state comprise at least one of SS/PBCH block resources or CSI-RS resources.

In one embodiment, the QCL types comprise ‘typeA’, ‘typeB’, ‘typeC’, and ‘typeD’.

In one embodiment, the QCL types comprise at least one of ‘typeA’, ‘typeB’, ‘typeC’ or ‘typeD’.

In one embodiment, the QCL types comprise at least ‘typeD’ in ‘typeA’, ‘typeB’, ‘typeC’ or ‘typeD’.

In one embodiment, ‘typeA’ comprises Doppler shift, Doppler spread, average delay, and delay spread.

In one embodiment, ‘typeB’ comprises Doppler shift and Doppler spread.

In one embodiment, ‘typeC’ comprises Doppler shift and average delay.

In one embodiment, ‘typeD’ comprises Spatial Rx parameters.

In one embodiment, for specific meanings of ‘typeA’, ‘typeB’, ‘typeC’, and ‘typeD’, refer to chapter 5.1.5 in 3GPP TS38.214.

In one embodiment, the QCL parameters comprise one or multiple of delay spread, Doppler spread, Doppler shift, average delay or Spatial Rx parameter.

In one embodiment, the QCL comprises Doppler shift and Doppler spread.

In one embodiment, the QCL comprises Doppler shift and average delay.

In one embodiment, the QCL comprises Spatial Rx parameters.

In one embodiment, the QCL comprises at least one of the spatial Tx parameters or spatial Rx parameters.

In one embodiment, the QCL comprises a spatial domain receive filter.

In one embodiment, the QCL comprises a spatial domain filter.

In one embodiment, the QCL comprises at least one of spatial domain transmit filter or spatial domain receive filter.

In one embodiment, a CORESET (Control Resource Set) comprises multiple RE (Resource Elements).

Typically, an RE occupies a subcarrier in frequency domain and a symbol in time domain.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the symbol is obtained after an output of transform precoding is through OFDM symbol generation.

In one embodiment, the symbol is a Single Carrier-Frequency Division Multiple Access (SC-FDMA) symbol.

In one embodiment, the symbol is a Discrete Fourier Transform Spread OFDM (DFT-S-OFDM) symbol.

In one embodiment, the multicarrier symbol is a Filter Bank Multi-Carrier (FBMC) symbol.

In one embodiment, the multicarrier symbol comprises a Cyclic Prefix (CP).

In one embodiment, a CORESET (Control Resource Set) comprises at least one CCE (Control Channel Element).

In one embodiment, a CCE comprises 9 Resource Element Groups (REGs), and an REG comprises 4 REs.

In one embodiment, an CCE comprises 6 REGs, and an REG comprises 12 REs.

In one embodiment, a CORESET is configured by an RRC IE (Information Element) ControlResourceSet.

In one embodiment, for the specific meaning of CORESET, refer to chapter 10 in 3GPP TS 38.213.

In one embodiment, for the specific meaning of RRC IE ControlResourceSet, refer to chapter 6.3.2 in 3GPP TS 38.331.

In one embodiment, a CORESET corresponds to at least one SS (Search Space) set.

In one embodiment, any of the multiple CORESETs corresponds to one or multiple SS sets.

In one embodiment, any of the multiple CORESETs corresponds to only one SS set.

In one embodiment, an SS set corresponding to a CORESET is either a USS set or a CSS set.

In one embodiment, a PDCCH (Physical Downlink Control Channel) candidate in a CORESET belongs to the CORESET in frequency domain.

In one embodiment, a PDCCH candidate in a CORESET is a PDCCH candidate in an SS set corresponding to the CORESET.

In one embodiment, a PDCCH candidate in a CORESET consists of at least one CCE in the CORESET.

In one embodiment, any PDCCH candidate in an SS set corresponding to a CORESET consists of at least one CCE of the CORESET.

In one embodiment, a PDCCH candidate in an SS set corresponding to a CORESET belongs to the CORESET.

In one embodiment, the meaning of the phrase that “an SS set corresponds to a CORESET” comprises: an SS set corresponding to a CORESET is associated with the CORESET.

In one embodiment, the meaning that “an SS set is with a CORESET” comprises: configuration information of the SS set comprises an index of the CORESET.

In one embodiment, the meaning of the phrase that “an SS set corresponds to a CORESET” comprises: a CORESET is used to determine time-frequency resources occupied by an SS set corresponding to the CORESET in a PDCCH monitoring occasion.

In one embodiment, the meaning of the phrase that “an SS set corresponds to a CORESET” comprises: a CORESET comprises time-frequency resources occupied by an SS set corresponding to the CORESET in a PDCCH monitoring occasion.

In one embodiment, the meaning of the phrase that “an SS set corresponds to a CORESET” comprises: an RE occupied by a CORESET comprises an RE occupied by an SS set corresponding to the CORESET in a PDCCH monitoring occasion.

In one embodiment, the meaning of the phrase that “an SS set corresponds to a CORESET” comprises: RB(s) occupied by a CORESET in frequency domain comprises (comprise) RB(s) occupied by an SS set corresponding to a CORESET in frequency domain.

In one embodiment, the meaning of the phrase that “an SS set corresponds to a CORESET” comprises: frequency-domain resources occupied by a CORESET comprise frequency-domain resources occupied by an SS set corresponding to the CORESET.

In one embodiment, the meaning of the phrase that “an SS set corresponds to a CORESET” comprises: symbol(s) occupied by a CORESET is (are) used to determine symbol(s) occupied by an SS set corresponding to the CORESET in a PDCCH monitoring occasion.

In one embodiment, the meaning of the phrase that “an SS set corresponds to a CORESET” comprises: symbol(s) occupied by a CORESET comprises (comprise) symbol(s) occupied by an SS set corresponding to the CORESET in a PDCCH monitoring occasion.

In one embodiment, symbol(s) occupied by a CORESET in a PDCCH monitoring occasion belongs (belong) to symbol(s) occupied by the CORESET.

In one embodiment, symbol(s) occupied by a CORESET in a PDCCH monitoring occasion comprises (comprise) symbol(s) occupied by the CORESET.

In one embodiment, the meaning of the phrase that “an SS set corresponds to a CORESET” comprises: configuration information of an SS set corresponding to a CORESET comprises an index of the CORESET.

In one embodiment, the meaning of the phrase that “an SS set corresponds to a CORESET” comprises: an SS set corresponding to a CORESET is an SS set configured with an index of the CORESET.

In one embodiment, a PDCCH monitoring occasion comprises a time period.

In one embodiment, a PDCCH monitoring occasion comprises one or multiple symbols.

In one embodiment, a PDCCH monitoring occasion comprises a slot.

In one embodiment, a PDCCH monitoring occasion comprises a sub-slot.

In one embodiment, a PDCCH monitoring occasion comprises a subframe.

In one embodiment, a PDCCH monitoring occasion comprises one or multiple symbols in a slot.

In one embodiment, a PDCCH monitoring occasion comprises a symbol occupied by a CORESET in a slot.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or multiple UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the first node in the present application comprises the UE 241.

In one embodiment, the second node in the present application comprises the gNB 203.

### Embodiment 3

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the reference information block is generated by the RRC sublayer 306.

In one embodiment, the reference information block is generated by the MAC sublayer 302 or the MAC sublayer 352.

In one embodiment, the first information block is generated by the RRC sublayer 306.

In one embodiment, the first information block is generated by the MAC sublayer 302 or the MAC sublayer 352.

In one embodiment, the first information block is generated by the PHY 301 or the PHY 351.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or multiple parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DownLink) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory: The at least one memory comprises computer program codes: the at least one memory and the computer program codes are configured to be used in collaboration with the at least one processor. The second communication device 450 at least: receives a reference information block: herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, the second communication device 450 comprises a memory that stores a computer readable instruction program. The computer readable instruction program generates an action when executed by at least one processor. The action includes: receiving a reference information block: herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, the first communication device 410 comprises at least one processor and at least one memory: The at least one memory comprises computer program codes: the at least one memory and the computer program codes are configured to be used in collaboration with the at least one processor. The first communication device 410 at least: transmits a reference information block: herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, the first communication device 410 comprises a memory that stores a computer readable instruction program. The computer readable instruction program generates an action when executed by at least one processor. The action includes: transmitting a reference information block: herein, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the reference information block in the present application: at least one of the antenna 420, the transmitter 418, the transmitting processor 416, the multi-antenna transmitting processor 471, the controller/processor 475, or the memory 476 is used to transmit the reference information block in the present application.

In one embodiment, at least one of the antenna 452, the receiver 454, the receiving processor 456, the multi-antenna receiving processor 458, the controller/processor 459, the memory 460, or the data source 467 is used to receive the first information block in the present application: at least one of the antenna 420, the transmitter 418, the transmitting processor 416, the multi-antenna transmitting processor 471, the controller/processor 475, or the memory 476 is used to transmit the first information block in the present application.

### Embodiment 5

Embodiment 5 illustrates a flowchart of wireless transmission according to one embodiment in the present application, as shown in FIG. 5. In FIG. 5, a first node U1 and a second node N2 are respectively two communication nodes transmitted via an air interface.

The first node U1 receives a reference information block in step S5101: receives a first information block in step S5102:
the second node N2_transmits a reference information block in step S5201: transmits a first information block in step S5202.

In embodiment 5, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, the first node U1 is the first node in the present application.

In one embodiment, the second node N2 is the second node in the present application.

In one embodiment, an air interface between the second node N2 and the first node U1 comprises a radio interface between a base station and a UE.

In one embodiment, an air interface between the second node N2 and the first node U1 comprises a radio interface between a relay node and a UE.

In one embodiment, an air interface between the second node N2 and the first node U1 comprises a radio interface between a UE and a UE.

In one embodiment, a physical channel occupied by the reference information block comprises a PDSCH (Physical Downlink Shared Channel).

In one embodiment, a physical channel occupied by the first information block comprises a PDSCH (Physical Downlink Shared Channel).

In one embodiment, a physical channel occupied by the first information block comprises a PDCCH (Physical Downlink Control Channel).

In one embodiment, the reference information block and the first information block are carried by a same signaling.

In one embodiment, the reference information block and the first information block are carried by different signalings.

In one embodiment, a reception of the reference information block is earlier than a reception of the first information block.

In one embodiment, a reception of the reference information block is not earlier than a reception of the first information block.

In one embodiment, the reference information block and the first information block are received at the same time.

### Embodiment 6

Embodiment 6 illustrates a schematic diagram of a first information block according to one embodiment of the present application, as shown in FIG. 6.

In embodiment 6, the first receiver receives a first information block; herein, the first information block is used to determine a reference time-domain resource set; the two TCI states of the target CORESET respectively indicate QCL information of a DMRS antenna port for a PDCCH reception in the target CORESET in a PDCCH monitoring occasion in the reference time-domain resource set, and QCL information of a DMRS antenna port for a PDCCH reception in the target CORESET in a PDCCH monitoring occasion outside the reference time-domain resource set.

In one embodiment, the first information block is carried by a higher-layer signaling.

In one embodiment, the first information block is carried by an RRC (Radio Resource Control) signaling.

In one embodiment, the first information block comprises all or partial fields in an RRC IE (Information Element).

In one embodiment, the first information block comprises all or partial fields in each RRC IE in multiple RRC IEs.

In one embodiment, the first information block comprises all or partial fields in a TDD-UL-DL-ConfigCommon IE.

In one embodiment, the first information block comprises all or partial fields in a TDD-UL-DL-ConfigDedicated IE.

In one embodiment, the first information block comprises all or partial fields in a ServingCellConfig IE.

In one embodiment, the first information block comprises all or partial fields in a ServingCellConfigCommonSIB IE.

In one embodiment, the first information block comprises information in all or partial fields in a ServingCellConfigCommon IE.

In one embodiment, the first information block is carried by at least one RRC IE.

In one embodiment, a name of an IE carrying the first information block comprises TDD-UL-DL-Configure.

In one embodiment, a name of an IE carrying the first information block comprises ServingCellConfig.

In one embodiment, the first information block is carried by a Medium Access Control layer Control Element (MAC CE).

In one embodiment, the first information block comprises a MAC CE.

In one embodiment, the first information block is transmitted on a downlink physical layer data channel (i.e., a downlink channel capable of carrying physical layer data).

In one embodiment, the first information block is transmitted on a PDSCH.

In one embodiment, the first information block is carried by DCI (Downlink control information).

In one embodiment, the first information block comprises DCI.

In one embodiment, the first information block comprises one or multiple fields in a DCI.

In one embodiment, the first information block is carried by DCI format 2_0.

In one embodiment, the first information block comprises DCI format 2_0.

In one embodiment, the first information block is carried by an RRC signaling and a MAC CE together.

In one embodiment, the first information block is carried by a higher layer signaling and DCI together.

In one embodiment, the first information block is carried by an RRC signaling and a DCI signaling together.

In one embodiment, the first information block is used to indicate a reference time-frequency resource set.

In one embodiment, the first information block explicitly indicates a reference time-frequency resource set.

In one embodiment, the first information block implicitly indicates a reference time-frequency resource set.

In one embodiment, the first information block indicates time-domain resources occupied by a reference time-frequency resource set and frequency-domain resources occupied by the reference time-frequency resource set.

In one embodiment, the first information block indicates a period and a time offset of a reference time-frequency resource set in time domain.

In one embodiment, the first information block indicates time-domain resources comprised in a reference time-frequency resource set within one cycle.

In one embodiment, the first information block indicates a symbol comprised in a reference time-frequency resource set within one cycle.

In one embodiment, the first information block indicates a slot comprised in a reference time-frequency resource set within one cycle.

In one embodiment, the first information block indicates an RB (Resource Block) comprised in a reference time-frequency resource set in frequency domain.

In one embodiment, the first information block indicates a subcarrier comprised in a reference time-frequency resource set in frequency domain.

In one embodiment, a transmitter of the first information block supports simultaneously receiving and transmitting a signal within time-domain resources occupied by the reference time-frequency resource set.

In one embodiment, a transmitter of the first information block simultaneously receives and transmits a signal in time-domain resources occupied by the reference time-frequency resource set.

In one embodiment, the reference time-frequency resource set comprises a positive integer number of symbol(s) in time domain.

In one embodiment, the reference time-frequency resource set comprises one or multiple symbols in time domain.

In one embodiment, the reference time-frequency resource set comprises at least one slot in time domain.

In one embodiment, the reference time-frequency resource set comprises at least one subframe in time domain.

In one embodiment, the reference time-frequency resource set in frequency domain comprises at least one RB in the first BWP.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the symbol is obtained after an output of transform precoding is through OFDM symbol generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multi-Carrier (FBMC) symbol.

In one embodiment, the multicarrier symbol comprises a Cyclic Prefix (CP).

In one embodiment, the reference time-frequency resource set is configured to the first BWP.

In one embodiment, the reference time-frequency resource set is configured to a serving cell where the first BWP is located.

In one embodiment, the reference time-frequency resource set is configured to an uplink BWP.

In one embodiment, the reference time-frequency resource set is configured to a downlink BWP.

In one embodiment, the first BWP is a downlink BWP.

In one embodiment, the first BWP is a downlink BWP, and the reference time-frequency resource set is configured to an uplink BWP corresponding to the first BWP.

In one embodiment, at least one PDCCH monitoring occasion of the target CORESET is in the reference time-domain resource set, and at least one PDCCH monitoring occasion of the target CORESET is outside the reference time-domain resource set.

In one embodiment, at least one PDCCH monitoring occasion of the target CORESET in the reference time-domain resource set and at least one PDCCH monitoring occasion of the target CORESET outside the reference time-domain resource set belong to a same search space.

In one embodiment, at least one PDCCH monitoring occasion of the target CORESET in the reference time-domain resource set and at least one PDCCH monitoring occasion of the target CORESET outside the reference time-domain resource set belong to different search spaces.

In one embodiment, the reference time-domain resource set comprises one or multiple symbols, at least one symbol in the reference time-domain resource set is configured as a DL symbol by higher-layer parameters, and one or multiple subcarriers in one or multiple DL symbols in the reference time-domain resource set are used for uplink transmission.

In one embodiment, the reference time-domain resource set comprises one or multiple symbols, at least one symbol in the reference time-domain resource set is configured as a DL symbol by higher-layer parameters, and one or multiple RBs in one or multiple DL symbols in the reference time-domain resource set are used for uplink transmission.

In one embodiment, the reference time-domain resource set comprises one or multiple symbols of a first type, and one or multiple subcarriers in one or multiple symbols of a first type of the reference time-domain resource set are used for uplink transmission.

In one embodiment, the reference time-domain resource set comprises one or multiple symbols of a first type, and one or multiple RBs in one or multiple symbols of a first type of the reference time-domain resource set are used for uplink transmission.

In one embodiment, any symbol in the reference time-domain resource set is configured as a DL symbol by higher-layer parameters.

In one embodiment, any symbol in the reference time-domain resource set is configured as a DL symbol or Flexible symbol by higher-layer parameters.

In one embodiment, the higher-layer parameters are RRC parameters.

In one embodiment, the higher-layer parameters comprise tdd-UL-DL-ConfigurationDedicated.

In one embodiment, the higher-layer parameters comprise tdd-UL-DL-ConfigurationCommon and tdd-UL-DL-ConfigurationDedicated.

In one embodiment, the higher-layer parameters comprise at least one of tdd-UL-DL-ConfigurationCommon or tdd-UL-DL-ConfigurationDedicated.

In one embodiment, for specific meanings of the tdd-UL-DL-ConfigurationCommon and the tdd-UL-DL-ConfigurationDedicated, refer to chapter 11 in 3GPP TS38.213.

In one embodiment, one or multiple RBs in one or multiple DL symbols of the reference time-domain resource set are used for uplink transmission.

In one embodiment, each symbol in the reference time-domain resource set is configured as a DL symbol by higher-layer parameters.

In one embodiment, each symbol in the reference time-domain resource set is configured as a DL symbol or Flexible symbol by higher-layer parameters.

In one embodiment, at least one symbol in the reference time-domain resource set is configured as a DL symbol by higher-layer parameters, and at least one symbol in the reference time-domain resource set is configured as a Flexible symbol by higher-layer parameters.

In one embodiment, the reference time-domain resource set is allocated to a serving cell.

In one embodiment, the reference time-domain resource set is configured to a serving cell where the first RS resource set is located.

In one embodiment, the reference time-domain resource set is configured to at least one BWP.

In one embodiment, the reference time-domain resource set is allocated to a BWP.

In one embodiment, the reference time-domain resource set is allocated to a DL BWP.

In one embodiment, the reference time-domain resource set is configured to a DL BWP where the first RS resource set is located.

In one embodiment, the uplink transmission in one or multiple DL symbols of the reference time-domain resource set comprises at least one of PUSCH (Physical Uplink Shared Channel), PUCCH (Physical Uplink Control Channel), PRACH (Physical Random Access Channel), or SRS (Sounding Reference Signal).

In one embodiment, the uplink transmission in one or multiple DL symbols of the reference time-domain resource set comprises a PUSCH.

In one embodiment, the uplink transmission in one or multiple DL symbols of the reference time-domain resource set comprises a PUCCH.

In one embodiment, the uplink transmission in one or multiple DL symbols of the reference time-domain resource set comprises a PRACH.

In one embodiment, the uplink transmission in one or multiple DL symbols of the reference time-domain resource set comprises an SRS.

In one embodiment, the first receiver receives a second information block: herein, the second information block is used to determine reference frequency-domain resource set: UL transmission in one or multiple DL symbols of the reference frequency-domain resource set belongs to the reference frequency-domain resource set in frequency domain.

In one embodiment, the second information block is carried by a higher-layer signaling.

In one embodiment, the second information block is carried by an RRC signaling.

In one embodiment, the second information block comprises partial or all fields in one or multiple RRC IEs.

In one embodiment, the second information block comprises partial fields in one or multiple RRC IEs.

In one embodiment, the second information block comprises partial fields in multiple RRC IEs.

In one embodiment, the second information block comprises all or partial fields in an RRC IE (Information Element).

In one embodiment, the second information block comprises partial fields in an RRC IE (Information Element).

In one embodiment, the second information block is carried by a MAC CE signaling.

In one embodiment, the second information block is carried by a physical-layer signaling.

In one embodiment, the second information block is carried by a DCI signaling.

In one embodiment, at least one RS resource in the first RS resource set is orthogonal to the reference frequency-domain resource set in frequency domain.

In one embodiment, at least one RS resource in the first RS resource set overlaps with the reference frequency-domain resource set in frequency domain.

In one embodiment, at least one RS resource in the first RS resource set comprises at least one subcarrier in the reference frequency-domain resource set in frequency domain.

In one embodiment, frequency-domain resources occupied by at least one RS resource in the first RS resource set belong to the reference frequency-domain resource set.

In one embodiment, frequency-domain resources occupied by at least one RS resource in the first RS resource set comprise at least one subcarrier in the reference frequency-domain resource set and at least one subcarrier outside the reference frequency-domain resource set.

In one embodiment, any RS resource in the first RS resource set overlaps with the reference frequency-domain resource set in frequency domain.

In one embodiment, any RS resource in the first RS resource set comprises at least one subcarrier in the reference frequency-domain resource set in frequency domain.

In one embodiment, frequency-domain resources occupied by any RS resource in the first RS resource set belong to the reference frequency-domain resource set.

In one embodiment, frequency-domain resources occupied by any RS resource in the first RS resource set comprise at least one subcarrier in the reference frequency-domain resource set and at least one subcarrier outside the reference frequency-domain resource set.

In one embodiment, the reference frequency-domain resource set comprises partial or all RBs of a DL BWP.

In one embodiment, the reference frequency-domain resource set comprises partial RBs of a DL BWP.

In one embodiment, the reference frequency-domain resource set comprises partial or all RBs of the first BWP.

In one embodiment, the reference frequency-domain resource set comprises partial RBs of the first BWP.

In one embodiment, the reference frequency-domain resource set comprises partial or all RBs of a DL BWP where the first RS resource set is located.

In one embodiment, the reference frequency-domain resource set comprises partial or all RBs of a serving cell where the first RS resource set is located.

In one embodiment, the reference frequency-domain resource set comprises partial RBs of a DL BWP where the first RS resource set is located.

In one embodiment, the reference frequency-domain resource set comprises partial RBs of a serving cell where the first RS resource set is located.

In one embodiment, on a serving cell, UL transmission in one or multiple DL symbols of the reference frequency-domain resource set belongs to the reference frequency-domain resource set in frequency domain.

In one embodiment, on a BWP, UL transmission in one or multiple DL symbols of the reference frequency-domain resource set belongs to the reference frequency-domain resource set in frequency domain.

In one embodiment, on a DL BWP, UL transmission in one or multiple DL symbols of the reference frequency-domain resource set belongs to the reference frequency-domain resource set in frequency domain.

In one embodiment, on a first one of BWPs, UL transmission in one or multiple DL symbols of the reference frequency-domain resource set belongs to the reference frequency-domain resource set in frequency domain.

In one embodiment, on a serving cell where the first RS resource set is located, UL transmission in one or multiple DL symbols of the reference frequency-domain resource set belongs to the reference frequency-domain resource set in frequency domain.

In one embodiment, on a DL BWP where the first RS resource set is located, UL transmission in one or multiple DL symbols of the reference frequency-domain resource set belongs to the reference frequency-domain resource set in frequency domain.

In one embodiment, on the first BWP, UL transmission in one or multiple DL symbols of the reference frequency-domain resource set belongs to the reference frequency-domain resource set in frequency domain.

In one embodiment, the second information block is used by the first node to determine the reference frequency-domain resource set.

In one embodiment, the second information block indicates the reference frequency-domain resource set.

In one embodiment, “the second information indicates the reference frequency-domain resource set” refers to: the second information block explicitly indicates the reference frequency-domain resource set.

In one embodiment, “the second information indicates the reference frequency-domain resource set” refers to: the second information block implicitly indicates the reference frequency-domain resource set.

In one embodiment, the second information block indicates a reference frequency-domain resource pool, and the reference frequency-domain resource set belongs to the reference frequency-domain resource pool.

In one embodiment, the second information block indicates a reference frequency-domain resource pool, and the reference frequency-domain resource set comprises at least one RB overlapping with a first BWP in the reference frequency-domain resource pool.

In one embodiment, the second information block indicates a reference frequency-domain resource pool, and the reference frequency-domain resource set comprises all RBs overlapping with a first DL BWP in the reference frequency-domain resource pool.

In one embodiment, the second information block indicates a reference frequency-domain resource pool, and the reference frequency-domain resource set comprises at least one RB in reference frequency-domain resource pool that overlap with a DL BWP where the first RS resource set is located.

In one embodiment, the second information block indicates a reference frequency-domain resource pool, and the reference frequency-domain resource set comprises all RBs in the reference frequency-domain resource pool that overlap with a DL BWP where the first RS resource set is located.

In one embodiment, the first information block and the second information block belong to a same RRC IE.

In one embodiment, the first information block and the second information block respectively belong to two RRC IEs.

In one embodiment, the first information block and the second information block are received at the same time.

In one embodiment, the first information block and the second information block are received together.

In one embodiment, a reception of the first information block is earlier than a reception of the second information block.

In one embodiment, a reception of the first information block is not earlier than a reception of the second information block.

### Embodiment 7

Embodiment 7 illustrates a schematic diagram of a first TCI state set according to one embodiment of the present application, as shown in FIG. 7; in FIG. 7, one TCI state and another TCI state are two TCI states of a target CORESET, wherein the first TCI state indicates QCL information of a DMRS antenna port for a PDCCH reception in the target CORESET in a PDCCH monitoring occasion outside the reference time-domain resource set, and the first TCI state set comprises the TCI state.

In embodiment 7, the first TCI state set comprises a TCI state indicating QCL information of a DMRS antenna port for a PDCCH reception in the target CORESET in a PDCCH monitoring occasion outside the reference time-domain resource set in the two TCI states of the target CORESET.

In one embodiment, the two TCI states of the target CORESET comprise a first TCI state and a second TCI state: the first TCI state indicates QCL information of a DMRS antenna port for a PDCCH reception in the target CORESET in a PDCCH monitoring occasion outside the reference time-domain resource set: the second TCI state indicates QCL information of a DMRS antenna port for a PDCCH reception in the target CORESET in a PDCCH monitoring occasion in the reference time-domain resource set: the first TCI state set comprises only the first one of TCI states in the two TCI states of the target CORESET.

In one embodiment, the two TCI states of the target CORESET comprise a first TCI state and a second TCI state: the first TCI state indicates QCL information of a DMRS antenna port for a PDCCH reception in the target CORESET in a PDCCH monitoring occasion outside the reference time-domain resource set: the second TCI state indicates QCL information of a DMRS antenna port for a PDCCH reception in the target CORESET in a PDCCH monitoring occasion outside the reference time-domain resource set: the first TCI state set comprises the first TCI state and the second TCI state of the target CORESET.

In one embodiment, the two TCI states of the target CORESET comprise a first TCI state and a second TCI state: the first TCI state indicates QCL information of a DMRS antenna port for a PDCCH reception in the target CORESET in a PDCCH monitoring occasion outside the reference time-domain resource set: the second TCI state indicates QCL information of a DMRS antenna port for a PDCCH reception in the target CORESET in a PDCCH monitoring occasion in the reference time-domain resource set: the first TCI state set does not comprise the first TCI state and the second TCI state of the target CORESET.

In one embodiment, the two TCI states of the target CORESET comprise a first TCI state and a second TCI state: the first TCI state indicates QCL information of a DMRS antenna port for a PDCCH reception in the target CORESET in a PDCCH monitoring occasion in the reference time-domain resource set: the second TCI state indicates QCL information of a DMRS antenna port for a PDCCH reception in the target CORESET in a PDCCH monitoring occasion in the reference time-domain resource set: the first TCI state set does not comprise the first TCI state and the second TCI state of the target CORESET.

### Embodiments 8A-8B

Embodiments 8A-8B illustrate a schematic diagram of configuration information of a first serving cell and a target CORESET according to one embodiment of the present application, as shown in FIGS. 8A-8B.

In embodiment 8A, configuration information of the first serving cell does not comprise a higher-layer parameter configuring SFN (Single Frequency Network) scheme for PDCCH.

In embodiment 8B, configuration information of the target CORESET does not comprise a higher-layer parameter for configuring a PDCCH to use SFN scheme.

In one embodiment, the higher-layer parameters for configuring a PDCCH to use SFN (single frequency network) scheme is sfnSchemePDCCH-r17.

In one embodiment, a name of the higher-layer parameter for configuring a PDCCH to use SFN scheme comprises sfnSchemePdcch.

In one embodiment, a name of the higher-layer parameter for configuring a PDCCH to use SFN scheme comprises sfn.

In one embodiment, a value range of the sfnSchemePdcch comprises ‘sfnSchemeA’ and ‘sfnSchemeB’.

In one embodiment, for specific meanings of the sfnSchemePdcch, ‘sfnSchemeA’, and ‘sfnSchemeB’, refer to chapter 5.1.5 in 3GPP TS38.214.

In one embodiment, a PDCCH on the first serving cell does not use the SFN scheme.

In one embodiment, a PDCCH on the target CORESET does not use the SFN scheme.

In one embodiment, any two PDCCHs on the first serving cell are not transmitted on same time-domain resources and same frequency-domain resources.

In one embodiment, there do not exist two PDCCHs being transmitted on same time-domain resources and same frequency-domain resources in the first serving cell.

### Embodiment 9

Embodiment 9 illustrates a schematic diagram of a relation between a first TCI state and two TCI states of a reference CORESET according to one embodiment of the present application, as shown in FIG. 9.

In embodiment 9, a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

In one embodiment, the first TCI state set comprises only one TCI state of the reference CORESET or two TCI states depending on whether the two TCI states of the reference CORESET indicate QCL information of a DMRS antenna port for a PDCCH reception in the target CORESET in different PDCCH monitoring occasions.

In one embodiment, both the two TCI states of the reference CORESET indicate RS resources configured with QCL type ‘typeD’.

In one embodiment, when a DMRS port of a PDCCH in the reference CORESET and RSs indicated by the two TCI states of the reference CORESET are QCLed, the two TCI states of the reference CORESET indicate QCL information of a DMRS antenna port for a PDCCH reception in a same PDCCH monitoring occasion.

In one embodiment, when a DMRS port of a PDCCH in the reference CORESET and RSs indicated by the two TCI states of the reference CORESET are QCLed, the two TCI states of the reference CORESET are simultaneously used for a PDCCH reception in the reference CORESET.

In one embodiment, when the two TCI states of the reference CORESET respectively indicate QCL information of a DMRS antenna port for a PDCCH reception in different PDCCH monitoring occasions, in one PDCCH monitoring occasion, a DMRS port of a PDCCH in the reference CORESET and only one of the two TCI states in the reference CORESET are QCLed.

In one embodiment, when the two TCI states of the reference CORESET respectively indicate QCL information of a DMRS antenna port for a PDCCH reception in different PDCCH monitoring occasions, the two TCI states in the reference CORESET are not simultaneously used to receive a PDCCH in the reference CORESET.

In one embodiment, when the reference CORESET is transmitted using the SFN scheme, a DMRS port of a PDCCH in the reference CORESET and RSs indicated by the two TCI states of the reference CORESET are QCLed.

In one embodiment, when the reference CORESET is transmitted not using the SFN scheme, the two TCI states of the reference CORESET respectively indicate QCL information of a DMRS antenna port for a PDCCH reception in the reference CORESET in different PDCCH monitoring occasions.

### Embodiment 10

Embodiment 10 illustrates a schematic diagram of triggering a beam failure recovery for a first serving cell according to one embodiment of the present application, as shown in FIG. 10.

In embodiment 10, when a value of a target counter is equal to or greater than a target threshold, a beam failure recovery for a first serving cell is triggered: herein, the first BWP is a BWP of the first serving cell; when the radio link quality assessed according to the first RS resource set is worse than a reference threshold, physical layer of the first node transmits a beam failure instance indication for the first serving cell to its higher layer: the target counter is used for counting the beam failure instance indication for the first serving cell.

Typically, the beam failure instance indication for a first serving cell is transmitted from the physical layer to its higher layer within the first node.

Typically, the beam failure recovery for the first serving cell is triggered by the first node in the present application.

Typically, the first serving cell is a serving cell where the first BWP is located.

In one embodiment, the radio link quality is one of RSRP, L1-RSRP, SINR, or L1-SINR: the meaning of the phrase that “the radio link quality is worse than a reference threshold” comprises: the radio link quality is less than the reference threshold.

In one subembodiment of the above embodiment, the reference threshold is measured by dBm or dB.

In one embodiment, the radio link quality is BLER: the meaning of the phrase that “the radio link quality is worse than a reference threshold” comprises: the radio link quality is greater than the reference threshold.

In one subembodiment of the above embodiment, the reference threshold is a BLER threshold.

In one embodiment, the radio link quality is hypothetical BLER: the meaning of the phrase that “the radio link quality is worse than a reference threshold” comprises: the radio link quality is greater than the reference threshold.

In one embodiment, the reference threshold is a real number.

In one embodiment, the reference threshold is a non-negative real number.

In one embodiment, the reference threshold is a non-negative real number not greater than 1.

In one embodiment, the reference threshold is Qout_L.

In one embodiment, the reference threshold is one of Qout_L, Qout_LR_SSB or Qout_LR_CSI-RS.

In one embodiment, for specific meanings of Qout_L, Qout_LR_SSB and Qout_LR_CSI-RS, refer to 3GPP TS38.133.

In one embodiment, the reference threshold is configured by an RRC parameter rlmInSyncOutOfSync Threshold.

In one embodiment, the reference threshold is a default value of rlmInSyncOutOfSync Threshold.

In one embodiment, for the specific meaning of rlmInSyncOutOfSyncThreshold, refer to chapter 6 in 3GPP TS38.213.

In one embodiment, for the specific meaning of rlmInSyncOutOfSyncThreshold, refer to 3GPP TS38.133.

Typically, the meaning of the phrase that “when a value of a target counter is equal to or greater than a target threshold” refers to: when and only when a value of a target counter is equal to or greater than a target threshold.

Typically, the meaning of the phrase that “when a value of a target counter is equal to or greater than a target threshold” refers to: as a response to a value of a target counter being equal to or greater than a target threshold.

Typically, the first node maintains the target counter at the MAC layer.

Typically, a MAC entity of the first node maintains the target counter.

Typically, when a MAC entity of the first node receives a beam failure instance indication from the physical layer for the first serving cell, it starts or restarts a target timer, and a value of the target counter is increased by 1.

Typically, the target counter is BFI_CONTER.

Typically, when the target timer expires, set the target counter to 0.

Typically, the target timer is beamFailureDetection Timer.

In one embodiment, the target counter is BFI_COUNTER.

In one embodiment, an initial value of the target counter is 0.

In one embodiment, the target threshold is a positive integer.

In one embodiment, the target threshold is beamFailureInstanceMaxCount.

In one embodiment, the target threshold is configured by RRC parameters.

In one embodiment, RRC parameters for configuring the target threshold comprise all or part of information in a beamFailureInstanceMaxCount field of a RadioLinkMonitoring IE.

In one embodiment, the target timer is beamFailureDetection Timer.

In one embodiment, an initial value of the target timer is a positive integer.

In one embodiment, an initial value of the target timer is a positive real number.

In one embodiment, an initial value of the target counter is measured by Qout, LR reporting period of a beam failure detection RS.

In one embodiment, an initial value of the target timer is configured by a higher-layer parameter beam FailureDetection Timer.

In one embodiment, an initial value of the target timer is configured by an IE.

In one embodiment, a name of IE configuring an initial value of the target timer comprises RadioLinkMonitoring.

In one embodiment, when beam failure recovery for the first serving cell is triggered, beam failure recovery procedure for the first serving cell comprises transmitting a first signal.

In one embodiment, the first signal comprises at least one of a contention-based Random Access preamble, a BFR MAC CE, a Truncated BFR MAC CE, an Enhanced BFR MAC CE, or a Truncated Enhanced BFR MAC CE.

In one embodiment, the first signal comprises a random access preamble.

In one embodiment, the first signal comprises a contention-free Random Access Preamble.

In one embodiment, the Beam Failure Recovery (BFR) for the first serving cell comprises a random access procedure.

In one embodiment, the Beam Failure Recovery (BFR) for the first serving cell comprises at least one of transmitting a random access preamble, transmitting a BFR MAC CE, transmitting a Truncated BFR MAC CE, transmitting an Enhanced BFR MAC CE, or transmitting a Truncated Enhanced BFR MAC CE.

In one embodiment, the random access preamble is a contention-based Random Access Preamble.

In one embodiment, the random access preamble is a contention-free Random Access Preamble.

In one embodiment, the Beam Failure Recovery (BFR) for the first serving cell comprises transmitting one of a BFR MAC CE, a Truncated BFR MAC CE, an Enhanced BFR MAC CE, or a Truncated Enhanced BFR MAC CE.

In one embodiment, the Beam Failure Recovery (BFR) for the first serving cell comprises transmitting a MAC CE whose name comprises BFR.

In one embodiment, if the first transceiver receives a response to the first signal, beam failure recovery for the first serving cell is successfully completed.

In one embodiment, the response for the first signal comprises an activation of a higher layer for a TCI state.

In one embodiment, the response for the first signal comprises an activation command for a higher-layer parameter tci-StatesPDCCH-ToAddList and/or tci-StatesPDCCH-ToReleaseList.

In one embodiment, the response to the first signal comprises a MAC CE used for indicating a PDCCH TCI.

In one embodiment, the response to the first signal comprises an RRC signaling used for configuring CORESET TCI-state.

In one embodiment, the response for the first signal comprises Downlink control information (DCI).

In one embodiment, the response to the first signal comprises a physical-layer signaling.

In one embodiment, the response to the first signal is transmitted on a PDCCH.

In one embodiment, the response to the first signal comprises Msg4.

In one embodiment, the response to the first signal comprises MsgB.

In one embodiment, the response for the first signal comprises a Contention Resolution PDSCH.

In one embodiment, a CRC of the response to the first signal is scrambled by a C-RNTI or a Modulation and Coding Scheme (MCS)-C-RNTI.

In one embodiment, a CRC of the response to the first signal is scrambled by a TC-RNTI.

In one embodiment, a CRC of the response to the first signal is scrambled by a C-RNTI.

In one embodiment, a CRC of the response to the first signal is scrambled by a MsgB-RNTI.

In one embodiment, a CRC of the response to the first signal is scrambled by a Random Access (RA)-RNTI.

In one embodiment, the first signal comprises a PUSCH transmission, and a HARQ (Hybrid Automatic Repeat reQuest) process number of the PUSCH is a first HARQ process number: the response to the first signal is a PUSCH scheduling DCI that indicates the first HARQ process number and a toggled NDI (New Data Indicator) field value.

In one embodiment, for the procedure of the beam failure recovery, refer to chapter 5.17 of 3GPP TS38. 321.

In one embodiment, for the procedure of the beam failure recovery, refer to chapter 6 of 3GPP TS38. 213.

### Embodiment 11

Embodiment 11 illustrates a schematic diagram of a radio link quality assessment of a first BWP according to one embodiment of the present application, as shown in FIG. 11.

In embodiment 11, the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool; when the radio link quality assessed according to the first RS resource set is worse than a reference threshold, physical layer of the first node transmits a beam failure instance indication for the first RS resource set to its higher layer: when the radio link quality assessed according to the second RS resource set is worse than the reference threshold, physical layer of the first node transmits a beam failure instance indication for the second RS resource set to its higher layer.

Typically, the first node respectively assesses radio link quality based on the first RS resource set and a second RS resource set.

In one embodiment, an index of the first CORESET pool is 0, and an index of the second CORESET pool is 1.

In one embodiment, an index of the first CORESET pool is 1, and an index of the second CORESET pool is 0.

In one embodiment, the first CORESET pool comprises at least one CORESET corresponding to CORESETPoolIndex of 0, and the second CORESET pool comprises at least one CORESET corresponding to CORESETPoolIndex of 1.

In one embodiment, the first CORESET pool comprises at least one CORESET corresponding to CORESETPoolIndex of 1, and the second CORESET pool comprises at least one CORESET corresponding to CORESETPoolIndex of 0.

In one embodiment, the reference information block indicates an index of a CORESET in a second CORESET pool on a first BWP.

In one embodiment, the reference information block indicates configuration information of a CORESET in a second CORESET pool on a first BWP.

In one embodiment, “a CORESET in a second CORESET pool” refers to: any CORESET in a second CORESET pool.

In one embodiment, “a CORESET in a second CORESET pool” refers to: each CORESET in a second CORESET pool.

In one embodiment, “a CORESET in a second CORESET pool” refers to: at least one CORESET in a second CORESET pool.

In one embodiment, “a CORESET in a second CORESET pool” refers to: partial CORESETs in a second CORESET pool.

In one embodiment, “a CORESET in a second CORESET pool” refers to: all CORESETs in a second CORESET pool.

In one embodiment, the second CORESET pool comprises one or multiple CORESETs.

In one embodiment, the second CORESET pool comprises multiple CORESETs.

In one embodiment, the first CORESET pool and the second CORESET pool together comprise up to 5 CORESETs.

In one embodiment, the meaning of the phrase that “the second RS resource set depends on a second TCI state set” comprises: any RS resource in the second RS resource set depends on the second TCI state set.

In one embodiment, the meaning of the phrase that “the second RS resource set depends on a second TCI state set” comprises: at least one RS resource in the second RS resource set depends on the second TCI state set.

In one embodiment, the meaning of the phrase that “the second RS resource set depends on a second TCI state set” comprises: the second TCI state set is dependent on by an RS resource set in the second RS resource set.

In one embodiment, the meaning of the phrase that “the second RS resource set depends on a second TCI state set” comprises: the second RS resource set is determined based on an RS index in an RS set indicated by the second TCI state set.

In one embodiment, the meaning of the phrase that “the second RS resource set depends on a second TCI state set” comprises: the second RS resource set is determined based on an RS index configured with QCL type ‘typeD’ in an RS set indicated by the second TCI state set.

In one embodiment, the meaning of the phrase that “the second RS resource set depends on a second TCI state set” comprises: the second RS resource set comprises at least one RS resource in an RS set indicated by the second TCI state set.

In one embodiment, the meaning of the phrase that “the second RS resource set depends on a second TCI state set” comprises: the second RS resource set comprises RS resources configured with QCL type ‘typeD’ in an RS set indicated by the second TCI state set.

In one embodiment, the meaning of the phrase that “the second RS resource set depends on a second TCI state set” comprises: the second RS resource set is determined based on a periodic CSI-RS resource configuration index with a same value as an RS index in an RS set indicated by the second TCI state set.

In one embodiment, the meaning of the phrase that “the second RS resource set depends on a second TCI state set” comprises: the second RS resource set is determined based on a periodic CSI-RS resource configuration index with a same value as an RS index configured with QCL type ‘typeD’ in an RS set indicated by the second TCI state set.

In one embodiment, the meaning of the phrase that “the second RS resource set depends on a second TCI state set” comprises: the second RS resource set is determined based on a periodic CSI-RS resource configuration index with a same value as an RS index in an RS set indicated by the second TCI state set: for a TCI state indicating multiple RS resources in the second TCI state set, the second RS resource set only comprises RS resources configured with QCL type ‘typeD’.

In one embodiment, the meaning of the phrase that “the second RS resource set depends on a second TCI state set” comprises: the second RS resource set comprises at least one periodic CSI-RS resource, and an index of the at least one periodic CSI-RS resource is the same as an RS index in an RS set indicated by the second TCI state set.

In one embodiment, the meaning of the phrase that “the second RS resource set depends on a second TCI state set” comprises: the second RS resource set comprises at least one periodic CSI-RS resource, and an index of the at least one periodic CSI-RS resource is the same as an RS index configured with QCL type ‘typeD’ in an RS set indicated by the second TCI state set.

In one embodiment, the meaning of the phrase that “the second RS resource set depends on a second TCI state set” comprises: the second RS resource set comprises at least one periodic CSI-RS resource, and an index of the at least one periodic CSI-RS resource is the same as an RS index in an RS set indicated by the second TCI state set: for a TCI state indicating multiple RS resources in the second TCI state set, the second RS resource set only comprises RS resources configured with QCL type ‘typeD’.

In one embodiment, the meaning of the phrase that “the second RS resource set depends on a second TCI state set” comprises: the second RS resource set is determined based on an SS/PBCH block index with a same value as an RS index in an RS set indicated by the second TCI state set.

In one embodiment, the meaning of the phrase that “the second RS resource set depends on a second TCI state set” comprises: the second RS resource set is determined based on an SS/PBCH block index with a same value as an RS index configured with QCL type ‘typeD’ in an RS set indicated by the second TCI state set.

In one embodiment, the meaning of the phrase that “the second RS resource set depends on a second TCI state set” comprises: the second RS resource set is determined based on an SS/PBCH block index with a same value as an RS index in an RS set indicated by the second TCI state set: for a TCI state indicating multiple RS resources in the second TCI state set, the second RS resource set only comprises RS resources configured with QCL type ‘typeD’.

In one embodiment, the meaning of the phrase that “the second RS resource set depends on a second TCI state set” comprises: the second RS resource set comprises at least one SS/PBCH block, and an index of the at least one SS/PBCH block is the same as an RS index in an RS set indicated by the second TCI state set.

In one embodiment, the meaning of the phrase that “the second RS resource set depends on a second TCI state set” comprises: the second RS resource set comprises at least one SS/PBCH block, and an index of the at least one SS/PBCH block is the same as an RS index configured with QCL type ‘typeD’ in an RS set indicated by the second TCI state set.

In one embodiment, the meaning of the phrase that “the second RS resource set depends on a second TCI state set” comprises: the second RS resource set comprises at least one SS/PBCH block, and an index of the at least one SS/PBCH block is the same as an RS index in an RS set indicated by the second TCI state set: for a TCI state indicating multiple RS resources in the second TCI state set, the second RS resource set only comprises RS resources configured with QCL type ‘typeD’.

In one embodiment, the meaning of the phrase that “an index of the at least one periodic CSI-RS resource is the same as an RS index in an RS set indicated by the second TCI state set” comprises: an index of the at least one periodic CSI-RS resource comprises at least one RS index in an RS set indicated by the second TCI state set.

In one embodiment, the meaning of the phrase that “an index of the at least one periodic CSI-RS resource is the same as an RS index in an RS set indicated by the second TCI state set” comprises: an index of the at least one periodic CSI-RS resource comprises an RS index configured with QCL type ‘typeD’ in an RS set indicated by the second TCI state set.

In one embodiment, the meaning of the phrase that “an index of the at least one periodic CSI-RS resource is the same as an RS index in an RS set indicated by the second TCI state set” comprises: an index of the at least one periodic CSI-RS resource and an RS index configured with QCL type ‘typeD’ in an RS set indicated by the second TCI state set are the same.

In one embodiment, the meaning of the phrase that “an index of the at least one periodic CSI-RS resource is the same as an RS index in an RS set indicated by the second TCI state set” comprises: an index of any periodic CSI-RS resource in the at least one periodic CSI-RS resource is the same as an RS index indicated by a TCI state in the second TCI state set, and an RS index of any TCI state in the second TCI state set is the same as an index of a periodic CSI-RS resource in the second RS resource set.

In one embodiment, an index of a CSI-RS resource is a CSI-RS resource configuration index.

In one embodiment, an index of a CSI-RS resource is used to identify the CSI-RS resource.

In one embodiment, an index of a CSI-RS resource is used to identify a configuration of the CSI-RS resource.

In one embodiment, the meaning of the phrase that “an index of the at least one SS/PBCH block is the same as an RS index in an RS set indicated by the second TCI state set” comprises: an index of the at least one SS/PBCH block comprises at least one RS index in an RS set indicated by the second TCI state set.

In one embodiment, the meaning of the phrase that “an index of the at least one SS/PBCH block is the same as an RS index in an RS set indicated by the second TCI state set” comprises: an index of the at least one SS/PBCH block comprises an RS index configured with QCL type ‘typeD’ in an RS set indicated by the second TCI state set.

In one embodiment, the meaning of the phrase that “an index of the at least one SS/PBCH block is the same as an RS index in an RS set indicated by the second TCI state set” comprises: an index of the at least one SS/PBCH block and an RS index configured with QCL type ‘typeD’ in an RS set indicated by the second TCI state set are the same.

In one embodiment, the meaning of the phrase that “an index of the at least one SS/PBCH block is the same as an RS index in an RS set indicated by the second TCI state set” comprises: an index of any SS/PBCH block in at least one SS/PBCH block is the same as an RS index indicated by a TCI state in the second TCI state set, and an RS index indicated by any TCI state in the second TCI state set is the same as an index of an SS/PBCH block in the second RS resource set.

In one embodiment, an index of an SS/PBCH block is used to identify the SS/PBCH block.

In one embodiment, an index of an SS/PBCH block is used to identify a configuration of the SS/PBCH block.

In one embodiment, an index of a CSI-RS resource is an NZP-CSI-RS-ResourceId.

In one embodiment, an index of an SS/PBCH block is SSB-Index.

Typically, the beam failure instance indication for the first RS resource set is transmitted from the physical layer to its higher layer within the first node.

Typically, the beam failure instance indication for the second RS resource set is transmitted from the physical layer to its higher layer within the first node.

Typically, the statistics of a beam failure instance indication for the first RS resource set and the statistics of a beam failure instance indication for the second RS resource set are conducted separately.

Typically, a beam failure detection for the first RS resource set and a beam failure detection for the second RS resource set are performed separately.

Typically, a beam failure recovery of the first RS resource set and a beam failure recovery of the second RS resource set are triggered separately.

Typically, the first RS resource set and the second RS resource set are two beam failure detection RS sets, and a beam failure detection is performed per set of beam failure detection RSs.

Typically, the first RS resource set and the second RS resource set are two sets of beam failure detection RSs, and a beam failure recovery is performed per set of beam failure detection RSs.

In one embodiment, the second TCI state set comprises at least one TCI state of at least one CORESET used for monitoring a PDCCH in the second CORESET pool.

In one embodiment, a first counter is used for counting of beam failure instance indications for the first RS resource set, and the second counter is used for counting of beam failure instance indications for the second RS resource set: when a value of a first counter is equal to or greater than a first threshold, a beam failure recovery for the first RS resource set is triggered: when a value of the second counter is equal to or greater than a second threshold, a beam failure recovery for the second RS resource set is triggered.

Typically, the first RS resource set and the second RS resource set respectively correspond to two BFI_COUNTERs.

Typically, the first RS resource set corresponds to a first counter, and the second RS resource set corresponds to a second counter.

Typically, the meaning of the phrase that “when a value of a first counter is equal to or greater than a first threshold” refers to: when and only when a value of a first counter is equal to or greater than a first threshold. Typically; the meaning of the phrase that “when a value of a first counter is equal to or greater than a first threshold” refers to: as a response to a value of a first counter being equal to or greater than a first threshold.

Typically, the meaning of the phrase that “when a value of a second counter is equal to or greater than a second threshold” refers to: when and only when a value of a second counter is equal to or greater than a second threshold.

Typically, the meaning of the phrase that “when a value of a second counter is equal to or greater than a second threshold” refers to: as a response to a value of a second counter being equal to or greater than a second threshold.

Typically, the first node maintains the first counter at the MAC layer, and the first node maintains the second counter at the MAC layer.

Typically, a MAC entity of the first node maintains the first counter, and a MAC entity of the first node maintains the second counter.

Typically, when a MAC entity of the first node receives a beam failure instance indication from physical layer for the first RS resource set, it starts or restarts a first timer, and a value of the first counter is increased by 1: whenever a MAC entity of the first node receives a beam failure instance indication from the physical layer for the second RS resource set, it starts or restarts a second timer, and a value of the second counter is increased by 1.

Typically, the first counter and the second counter are two BFI_COUNTERs.

Typically, when the first timer expires, set the first counter to 0; when the second timer expires, set the second counter to 0.

In one embodiment, the first timer and the second timer are two beamFailureDetection Timers.

Typically, an initial value of the first counter is 0, and an initial value of the second counter is 0.

In one embodiment, the first threshold is a positive integer, and the second threshold is a positive integer.

In one embodiment, the first threshold and the first threshold are respectively configured beam FailureInstanceMaxCount-r17.

In one embodiment, a name of the first threshold comprises beamFailureInstanceMaxCount, and a name of the second threshold comprises beam FailureInstanceMaxCount.

In one embodiment, the first threshold and the second threshold are respectively configured by RRC parameters.

In one embodiment, the first threshold is the same as the second threshold.

In one embodiment, the first threshold and the second threshold are different.

In one embodiment, the first threshold and the second threshold are configured by partial or all fields in an RRC IE.

In one embodiment, an RRC message configuring the first threshold and the second threshold comprises two beamFailureInstanceMaxCount-r17 fields of a RadioLinkMonitoringConfig IE.

In one embodiment, an RRC message configuring the first threshold and the second threshold respectively comprises partial or all information in two failureDetectionSet1-r17 fields of a RadioLinkMonitoringConfig IE.

In one embodiment, an RRC message configuring the first threshold and the second threshold respectively comprises partial or all information in a field whose name comprises failureDetectionSet1 in a RadioLinkMonitoringConfig IE, and an RRC message configuring the first threshold and the second threshold respectively comprises partial or all information in a field whose name comprises failureDetectionSet2 in a RadioLinkMonitoringConfig IE.

In one embodiment, an initial value of the first timer is the same as an initial value of the second timer.

In one embodiment, an initial value of the first timer is different from an initial value of the second timer.

In one embodiment, an initial value of the first timer and an initial value of the second timer are configured by RRC parameters, respectively.

In one embodiment, the first timer and the second timer are two beamFailureDetection Timer-r17, respectively:

In one embodiment, names of the first timer and the second timer both comprise beam FailureDetection Timer-r17.

In one embodiment, an initial value of the first timer is a positive integer, and an initial value of the second timer is a positive integer.

In one embodiment, an initial value of the first timer is a positive real number, and an initial value of the second timer is a positive real number.

In one embodiment, a unit for measurement of an initial value of the first timer and a unit for measurement of an initial value of the second timer are both Qout, LR reporting periods of beam failure detection RS.

In one embodiment, an initial value of the first timer and an initial value of the first timer are configured by two higher-layer parameters beamFailureDetection Timer-r17, respectively.

In one embodiment, an initial value of the first timer and an initial value of the second timer are configured by two higher-layer parameters whose name comprise beamFailureDetectionTimer-r17, respectively.

In one embodiment, an initial value of the first timer and an initial value of the second timer are configured by an IE.

In one embodiment, a name of an IE configuring an initial value of the first timer and an initial value of the second timer comprises RadioLinkMonitoring.

Typically, when a beam failure recovery for the first RS resource set and a beam failure recovery for the second RS resource set are both triggered, and a beam failure recovery procedure for either the first RS resource set or the second RS resource set is not successfully completed, initiate a random access procedure.

In one embodiment, the Beam Failure Recovery (BFR) for the first RS resource set comprises transmitting one of a BFR MAC CE, a Truncated BFR MAC CE, an Enhanced BFR MAC CE, or a Truncated Enhanced BFR MAC CE; the Beam Failure Recovery (BFR) for the second RS resource set comprises transmitting one of a BFR MAC CE, a Truncated BFR MAC CE, an Enhanced BFR MAC CE, or a Truncated Enhanced BFR MAC CE.

In one embodiment, the Beam Failure Recovery (BFR) for the first RS resource set comprises a MAC CE whose transmission name comprises BFR, and the BFR for the second RS resource set comprises a MAC CE whose transmission name comprises BFR.

In one embodiment, when a beam failure recovery is triggered for only the first RS resource set in the first RS resource set or the second RS resource set, the beam failure recovery (BFR) for the first RS resource set comprises transmitting a first PUSCH, and the first PUSCH bears a MAC CE whose name comprises BFR: if the first transceiver receives a response for the first PUSCH, the beam failure recovery for the first RS resource set is successfully completed.

In one embodiment, if the first transceiver does not receive a response for the first PUSCH, the beam failure recovery for the first RS resource set is not successfully completed.

In one embodiment, the response for the first PUSCH comprises Downlink control information (DCI).

In one embodiment, the response for the first PUSCH comprises a physical-layer signaling.

In one embodiment, the response for the first PUSCH is transmitted on a PDCCH.

In one embodiment, the response for the first PUSCH is a PUSCH scheduling DCI indicating “a same process number as a process number of the first PUSCH” and “a toggled NDI field value”.

In one embodiment, when beam failure recovery is triggered for only the second RS resource set in the first RS resource set or the second RS resource set, the beam failure recovery (BFR) for the second RS resource set comprises transmitting a second PUSCH, and the second PUSCH bears a MAC CE whose name comprises BFR: if the first transceiver receives a response for the second PUSCH, the beam failure recovery for the second RS resource set is successfully completed.

In one embodiment, if the first transceiver does not receive a response for the second PUSCH, the beam failure recovery for the second RS resource set is not successfully completed.

In one embodiment, the response for the second PUSCH comprises Downlink control information (DCI).

In one embodiment, the response to the second PUSCH comprises a physical-layer signaling.

In one embodiment, the response to the second PUSCH is transmitted on a PDCCH.

In one embodiment, the response for the second PUSCH is a PUSCH scheduling DCI indicating “a process number same as a process number of the second PUSCH” and “a toggled NDI field value”.

### Embodiment 12

Embodiment 12 illustrates a structure block diagram of a processor in a first node according to one embodiment of the present application, as shown in FIG. 12. In FIG. 12, a processor 1200 in a first node comprises at least the first receiver 1201 in a first receiver 1201 or a first transceiver 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

In one embodiment, the first transceiver 1202 comprises at least one of the antenna 452, the transmitter 454, the transmitting processor 468, the multi-antenna transmitting processor 457, the controller/processor 459, the memory 460, or the data source 467 in Embodiment 4.

In one embodiment, the first transceiver 1202 comprises at least one of the antenna 452, the receiver/transmitter 454, the receiving processor 456, the transmitting processor 468, the multi-antenna receiving processor 458, the multi-antenna transmitting processor 457, the controller/processor 459, the memory 460 or the data source 467 in Embodiment 4.

The first receiver 1201 receives a reference information block:

In embodiment 12, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

In one embodiment, comprising:
the first receiver 1201 receives a first information block;
herein, the first information block is used to determine a reference time-domain resource set: the two TCI states of the target CORESET respectively indicate QCL information of a DMRS antenna port for a PDCCH reception in the target CORESET in a PDCCH monitoring occasion in the reference time-domain resource set, and QCL information of a DMRS antenna port for a PDCCH reception in the target CORESET in a PDCCH monitoring occasion outside the reference time-domain resource set.

In one embodiment, the first TCI state set comprises a TCI state indicating QCL information of a DMRS antenna port for a PDCCH reception in the target CORESET in a PDCCH monitoring occasion outside the reference time-domain resource set in the two TCI states of the target CORESET.

In one embodiment, configuration information of the first serving cell does not comprise a higher-layer parameter configuring SFN (Single Frequency Network) scheme for PDCCH: or, configuration information of the target CORESET does not comprise a higher-layer parameter for configuring a PDCCH to use SFN scheme.

In one embodiment, a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

In one embodiment, when a value of a target counter is equal to or greater than a target threshold, a beam failure recovery for a first serving cell is triggered: herein, the first BWP is a BWP of the first serving cell; when the radio link quality assessed according to the first RS resource set is worse than a reference threshold, physical layer of the first node transmits a beam failure instance indication for the first serving cell to its higher layer: the target counter is used for counting the beam failure instance indication for the first serving cell.

In one embodiment, the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool; when the radio link quality assessed according to the first RS resource set is worse than a reference threshold, physical layer of the first node transmits a beam failure instance indication for the first RS resource set to its higher layer; when the radio link quality assessed according to the second RS resource set is worse than the reference threshold, physical layer of the first node transmits a beam failure instance indication for the second RS resource set to its higher layer.

### Embodiment 13

Embodiment 13 illustrates a structure block diagram of a processor in a second node according to one embodiment of the present application, as shown in FIG. 13. In FIG. 13, a processor 1300 in a second node comprises a second transmitter 1301.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

The second transmitter 1301 transmits a reference information block;

In embodiment 13, the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool: a target CORESET is a CORESET including two TCI states in the first CORESET pool; the two TCI states of the target CORESET respectively indicate QCL (quasi co-location) information of a DMRS antenna port for a PDCCH reception in the target CORESET in different PDCCH monitoring occasions; the first TCI state set comprises only one of the two TCI states of the target CORESET.

In one embodiment, comprising:
the second transmitter 1301 transmits a first information block;
herein, the first information block is used to determine a reference time-domain resource set: the two TCI states of the target CORESET respectively indicate QCL information of a DMRS antenna port for a PDCCH reception in the target CORESET in a PDCCH monitoring occasion in the reference time-domain resource set, and QCL information of a DMRS antenna port for a PDCCH reception in the target CORESET in a PDCCH monitoring occasion outside the reference time-domain resource set.

In one embodiment, the first TCI state set comprises a TCI state indicating QCL information of a DMRS antenna port for a PDCCH reception in the target CORESET in a PDCCH monitoring occasion outside the reference time-domain resource set in the two TCI states of the target CORESET.

In one embodiment, configuration information of the first serving cell does not comprise a higher-layer parameter configuring SFN (Single Frequency Network) scheme for PDCCH: or, configuration information of the target CORESET does not comprise a higher-layer parameter for configuring a PDCCH to use SFN scheme.

In one embodiment, a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

In one embodiment, when a value of a target counter is equal to or greater than a target threshold, a beam failure recovery for a first serving cell is triggered: herein, the first BWP is a BWP of the first serving cell; when the radio link quality assessed according to the first RS resource set is worse than a reference threshold, physical layer of a receiver of the reference information block transmits a beam failure instance indication for the first serving cell to its higher layer: the target counter is used by the receiver of the reference information block for counting the beam failure instance indication for the first serving cell.

In one embodiment, the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool: when the radio link quality assessed according to the first RS resource set is worse than a reference threshold, physical layer of a receiver of the reference information block transmits a beam failure instance indication for the first RS resource set to its higher layer: when the radio link quality assessed according to the second RS resource set is worse than the reference threshold, physical layer of the receiver of the reference information block transmits a beam failure instance indication for the second RS resource set to its higher layer.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or multiple integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any changes and modifications made based on the embodiments described in the specification, if similar partial or complete technical effects can be achieved, shall be deemed obvious and fall within the scope of protection of the present invention.

What is claimed is:

1. A first node for wireless communications, comprising:
a first receiver, receiving a reference information block;
wherein the reference information block is used to configure a first CORESET (Control Resource Set) pool on a first BWP (BandWidth Part), and the first CORESET pool comprises at least one CORESET: a first RS (Reference Signal) resource set is used for a radio link quality assessment of the first BWP, the first RS resource set depends on a first TCI (Transmission Configuration Indication) state set, the first TCI state set comprises at least one TCI state of at least one CORESET in the first CORESET pool; a target CORESET is a CORESET including two TCI states in the first CORESET pool; the two TCI states of the target CORESET respectively indicate QCL (quasi co-location) information of a DMRS (Demodulation Reference Signal) antenna port for a PDCCH reception in the target CORESET in different PDCCH monitoring occasions; the first TCI state set comprises only one of the two TCI states of the target CORESET.

2. The first node according to claim 1, comprising:
the first receiver, receiving a first information block;
wherein the first information block is used to determine a reference time-domain resource set: the two TCI states of the target CORESET respectively indicate QCL information of a DMRS antenna port for a PDCCH (Physical Downlink Control Channel) reception in the target CORESET in a PDCCH monitoring occasion in the reference time domain resource set, and QCL information of a DMRS antenna port for a PDCCH reception in the target CORESET in a PDCCH monitoring occasion outside the reference time domain resource set.

3. The first node according to claim 2, wherein the first TCI state set comprises a TCI state indicating QCL information of a DMRS antenna port for a PDCCH reception in the target CORESET in a PDCCH monitoring occasion outside the reference time domain resource set in the two TCI states of the target CORESET.

4. The first node according to claim 1, wherein
configuration information of the first serving cell does not comprise a higher-layer parameter configuring SFN (Single Frequency Network) scheme for PDCCH;
or,
configuration information of the target CORESET does not comprise a higher-layer parameter configuring SFN scheme for PDCCH;
or,
a reference CORESET is a CORESET comprising two TCI states in the first CORESET pool: when a DMRS port of a PDCCH in the reference CORESET and RSs indicated by the two TCI states of the reference CORESET are QCLed (quasi co-located), the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

5. The first node according to claim 1, wherein
when a value of a target counter is equal to or greater than a target threshold, a beam failure recovery for a first serving cell is triggered: wherein the first BWP is a BWP of the first serving cell: when the radio link quality assessed according to the first RS resource set is worse than a reference threshold, physical layer of the first node transmits a beam failure instance indication for the first serving cell to its higher layer: the target counter is used for counting the beam failure instance indication for the first serving cell;
or,
the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool: when the radio link quality assessed according to the first RS resource set is worse than a reference threshold, physical layer of the first node transmits a beam failure instance indication for the first RS resource set to its higher layer: when the radio link quality assessed according to the second RS resource set is worse than the reference threshold, physical layer of the first node transmits a beam failure instance indication for the second RS resource set to its higher layer.

6. A second node for wireless communications, comprising:
a second transmitter, transmitting a reference information block;
wherein the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions; the first TCI state set comprises only one of the two TCI states of the target CORESET.

7. The second node according to claim 6, comprising:
the second transmitter, transmitting a first information block;
wherein the first information block is used to determine a reference time-domain resource set; the two TCI states of the target CORESET respectively indicate QCL information of a DMRS antenna port for a PDCCH reception in the target CORESET in a PDCCH monitoring occasion in the reference time domain resource set, and QCL information of a DMRS antenna port for a PDCCH reception in the target CORESET in a PDCCH monitoring occasion outside the reference time domain resource set.

8. The second node according to claim 7, wherein the first TCI state set comprises a TCI state indicating QCL information of a DMRS antenna port for a PDCCH reception in the target CORESET in a PDCCH monitoring occasion outside the reference time domain resource set in the two TCI states of the target CORESET.

9. The second node according to claim 6, wherein
configuration information of the first serving cell does not comprise a higher-layer parameter configuring SFN (Single Frequency Network) scheme for PDCCH for PDCCH;
or,
configuration information of the target CORESET does not comprise a higher-layer parameter configuring SFN scheme for PDCCH;
or,
a reference CORESET is a CORESET including two TCI states in the first CORESET pool; when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

10. The second node according to claim 6, wherein
when a value of a target counter is equal to or greater than a target threshold, a beam failure recovery for a first serving cell is triggered: wherein the first BWP is a BWP of the first serving cell; when the radio link quality assessed according to the first RS resource set is worse than a reference threshold, physical layer of a receiver of the reference information block transmits a beam failure instance indication for the first serving cell to its higher layer: the target counter is used by the receiver of the reference information block for counting the beam failure instance indication for the first serving cell;
or,
the radio link quality assessment of the first BWP comprises: respectively assessing radio link quality according to the first RS resource set and a second RS resource set: the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool: when the radio link quality assessed according to the first RS resource set is worse than a reference threshold, physical layer of a receiver of the reference information block transmits a beam failure instance indication for the first RS resource set to its higher layer: when the radio link quality assessed according to the second RS resource set is worse than the reference threshold, physical layer of the receiver of the reference information block transmits a beam failure instance indication for the second RS resource set to its higher layer.

11. A method in a first node for wireless communications, comprising:
receiving a reference information block;
wherein the reference information block is used to configure a first CORESET (Control Resource Set) pool on a first BWP, and the first CORESET pool comprises at least one CORESET: a first RS (Reference Signal) resource set is used for a radio link quality assessment of the first BWP, the first RS resource set depends on a first TCI state set, the first TCI state set comprises at least one TCI state of at least one CORESET in the first CORESET pool: a target CORESET is a CORESET including two TCI states in the first CORESET pool: the two TCI states of the target CORESET respectively indicate QCL (quasi co-location) information of a DMRS antenna port for a PDCCH reception in the target CORESET in different PDCCH monitoring occasions: the first TCI state set comprises only one of the two TCI states of the target CORESET.

12. The method according to claim 11, comprising:
receiving a first information block;
wherein the first information block is used to determine a reference time-domain resource set: the two TCI states of the target CORESET respectively indicate QCL information of a DMRS antenna port for a PDCCH reception in the target CORESET in a PDCCH monitoring occasion in the reference time domain resource set, and QCL information of a DMRS antenna port for a PDCCH reception in the target CORESET in a PDCCH monitoring occasion outside the reference time domain resource set.

13. The method according to claim 12, wherein the first TCI state set comprises a TCI state indicating QCL information of a DMRS antenna port for a PDCCH reception in the target CORESET in a PDCCH monitoring occasion outside the reference time domain resource set in the two TCI states of the target CORESET.

14. The method according to claim 11, wherein
configuration information of the first serving cell does not comprise a higher-layer parameter configuring SFN (Single Frequency Network) scheme for PDCCH for PDCCH;
or,
configuration information of the target CORESET does not comprise a higher-layer parameter configuring SFN scheme for PDCCH;
or,
a reference CORESET is a CORESET comprising two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

15. The method according to claim 11, wherein
when a value of a target counter is equal to or greater than a target threshold, a beam failure recovery for a first serving cell is triggered: wherein the first BWP is a BWP of the first serving cell; when the radio link quality assessed according to the first RS resource set is worse than a reference threshold, physical layer of the first node transmits a beam failure instance indication for the first serving cell to its higher layer: the target counter is used for counting the beam failure instance indication for the first serving cell;
or,
the radio link quality assessment of the first BWP comprises: respectively assessing radio link quality according to the first RS resource set and a second RS resource set; the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool; when the radio link quality assessed according to the first RS resource set is worse than a reference threshold, physical layer of the first node transmits a beam failure instance indication for the first RS resource set to its higher layer: when the radio link quality assessed according to the second RS resource set is worse than the reference threshold, physical layer of the first node transmits a beam failure instance indication for the second RS resource set to its higher layer.

16. A method in a second node for wireless communications, comprising:
transmitting a reference information block;
wherein the reference information block is used to configure a first CORESET (Control Resource Set) pool on a first BWP, and the first CORESET pool comprises at least one CORESET; a first RS (Reference Signal) resource set is used for a radio link quality assessment of the first BWP, the first RS resource set depends on a first TCI state set, the first TCI state set comprises at least one TCI state of at least one CORESET in the first CORESET pool: a target CORESET is a CORESET including two TCI states in the first CORESET pool; the two TCI states of the target CORESET respectively indicate QCL (quasi co-location) information of a DMRS antenna port for a PDCCH reception in the target CORESET in different PDCCH monitoring occasions; the first TCI state set comprises only one of the two TCI states of the target CORESET.

17. The method according to claim 16, comprising:
transmitting a first information block;
wherein the first information block is used to determine a reference time-domain resource set; the two TCI states of the target CORESET respectively indicate QCL information of a DMRS antenna port for a PDCCH reception in the target CORESET in a PDCCH monitoring occasion in the reference time domain resource set, and QCL information of a DMRS antenna port for a PDCCH reception in the target CORESET in a PDCCH monitoring occasion outside the reference time domain resource set.

18. The method according to claim 17, wherein the first TCI state set comprises a TCI state indicating QCL information of a DMRS antenna port for a PDCCH reception in the target CORESET in a PDCCH monitoring occasion outside the reference time domain resource set in the two TCI states of the target CORESET.

19. The method according to claim 16, wherein
configuration information of the first serving cell does not comprise a higher-layer parameter configuring SFN (Single Frequency Network) scheme for PDCCH for PDCCH;
or,
configuration information of the target CORESET does not comprise a higher-layer parameter configuring SFN scheme for PDCCH;
or,
a reference CORESET is a CORESET including two TCI states in the first CORESET pool: when a DMRS port of a PDCCH in the reference CORESET and RSs indicated by the two TCI states of the reference CORESET are QCLed, the first TCI state set comprises the two TCI states of the reference CORESET: when the two TCI states of the reference CORESET respectively indicate QCL information of a DMRS antenna port for a PDCCH reception in the reference CORESET in different PDCCH monitoring occasions, the first TCI state set comprises only one of the two TCI states of the reference CORESET.

20. The method according to claim 16, wherein
when a value of a target counter is equal to or greater than a target threshold, a beam failure recovery for a first serving cell is triggered: wherein the first BWP is a BWP of the first serving cell; when the radio link quality assessed according to the first RS resource set is worse than a reference threshold, physical layer of a receiver of the reference information block transmits a beam failure instance indication for the first serving cell to its higher layer; the target counter is used by the receiver of the reference information block for counting the beam failure instance indication for the first serving cell;
or,
the radio link quality assessment of the first BWP comprises: respectively assessing radio link quality according to the first RS resource set and a second RS resource set; the reference information block is used to configure a second CORESET pool on the first BWP, the second CORESET pool comprises at least one CORESET, the second RS resource set depends on a second TCI state set, and the second TCI state set comprises at least one TCI state of at least one CORESET in the second CORESET pool; when the radio link quality assessed according to the first RS resource set is worse than a reference threshold, physical layer of a receiver of the reference information block transmits a beam failure instance indication for the first RS resource set to its higher layer: when the radio link quality assessed according to the second RS resource set is worse than the reference threshold, physical layer of the receiver of the reference information block transmits a beam failure instance indication for the second RS resource set to its higher layer.
